(19) United States
(12) Patent Application Publication
(10) Pub. No.: US 2019/0147296 A1
(43) Pub. Date: May 16, 2019

(54) CREATING AN IMAGE UTILIZING A MAP REPRESENTING DIFFERENT CLASSES OF PIXELS

(71) Applicant: NVIDIA Corporation, Santa Clara, CA (US)

(72) Inventors: Ting-Chun Wang, San Jose, CA (US); Ming-Yu Liu, Sunnyvale, CA (US); Bryan Christopher Catanzaro, Cupertino, CA (US); Jan Kautz, Lexington, MA (US); Andrew J. Tao, San Francisco, CA (US)

(21) Appl. No.: 16/188,920

(22) Filed: Nov. 13, 2018

Related U.S. Application Data
(60) Provisional application No. 62/586,743, filed on Nov. 15, 2017.

(51) Int. Cl. G06K 9/62; G06K 9/68; G06K 9/72

(52) U.S. Cl. CPC G06K 9/6257; G06K 9/726; G06K 9/6857

(57) ABSTRACT

A method, computer readable medium, and system are disclosed for creating an image utilizing a map representing different classes of specific pixels within a scene. One or more computing systems use the map to create a preliminary image. This preliminary image is then compared to an original image that was used to create the map. A determination is made whether the preliminary image matches the original image, and results of the determination are used to adjust the computing systems that created the preliminary image, which improves a performance of such computing systems. The adjusted computing systems are then used to create images based on different input maps representing various object classes of specific pixels within a scene.

### CLAIM OF PRIORITY

This application claims the benefit of U.S. Provisional Application No. 62/586,743 (Attorney Docket No. NVIDP1197+/17-SC-0263-US01) titled “High-Resolution Image Synthesis and Semantic Manipulation with Conditional GANs” filed Nov. 15, 2017, the entire contents of which is incorporated herein by reference.

### FIELD OF THE INVENTION

The present invention relates to image rendering, and more particularly to rendering images utilizing a semantic representation.

### BACKGROUND

Rendering photo-realistic images using standard graphics techniques may be an involved process, since geometry, materials and light transport are simulated explicitly. Additionally, building and editing virtual environments is expensive and time-consuming, since each part of the virtual world needs to be modeled explicitly. As a result, it is desirable to render photo-realistic images using a model learned from data, which may convert the process of rendering graphics into a model learning and inference problem. There is therefore a need for addressing these issues and/or other issues associated with the prior art.

### BRIEF DESCRIPTION OF THE DRAWINGS

FIG. 1 illustrates a flowchart of a method for creating an image utilizing a map representing different classes of pixels, in accordance with an embodiment.

FIG. 2 illustrates a parallel processing unit, in accordance with an embodiment.

FIG. 3A illustrates a general processing cluster within the parallel processing unit of FIG. 2, in accordance with an embodiment.

FIG. 3B illustrates a memory partition unit of the parallel processing unit of FIG. 2, in accordance with an embodiment.

FIG. 4A illustrates the streaming multi-processor of FIG. 3A, in accordance with an embodiment.

FIG. 4B is a conceptual diagram of a processing system implemented using the PPU of FIG. 2, in accordance with an embodiment.

FIG. 4C illustrates an exemplary system in which the various architecture and/or functionality of the various previous embodiments may be implemented.

FIG. 5 is a conceptual diagram of a graphics processing pipeline implemented by the PPU of FIG. 2, in accordance with an embodiment.

FIG. 6 illustrates an exemplary network architecture of a generator, in accordance with an embodiment.

FIG. 7 illustrates an exemplary trained encoder architecture, in accordance with an embodiment.

FIG. 8 illustrates a flowchart of a method for training a coarse-to-fine generator, in accordance with an embodiment.

FIG. 9 illustrates a flowchart of a method for implementing a trained coarse-to-fine generator, in accordance with an embodiment.

FIG. 10 illustrates a flowchart of a method for refining output utilizing an instance feature map, in accordance with an embodiment.

FIG. 11 illustrates a flowchart of a method for training a machine learning model based, at least in part, on a semantic representation of a first digital representation of an image, in accordance with an embodiment.

FIG. 12 illustrates a flowchart of a method for training a machine learning model based, at least in part, on a semantic representation of a first digital representation of an image, in accordance with an embodiment.

FIG. 13 illustrates an exemplary machine learning model, in accordance with an embodiment.

FIG. 14 illustrates a flowchart of a method for using a trained generator architecture, in accordance with an embodiment.

### DETAILED DESCRIPTION

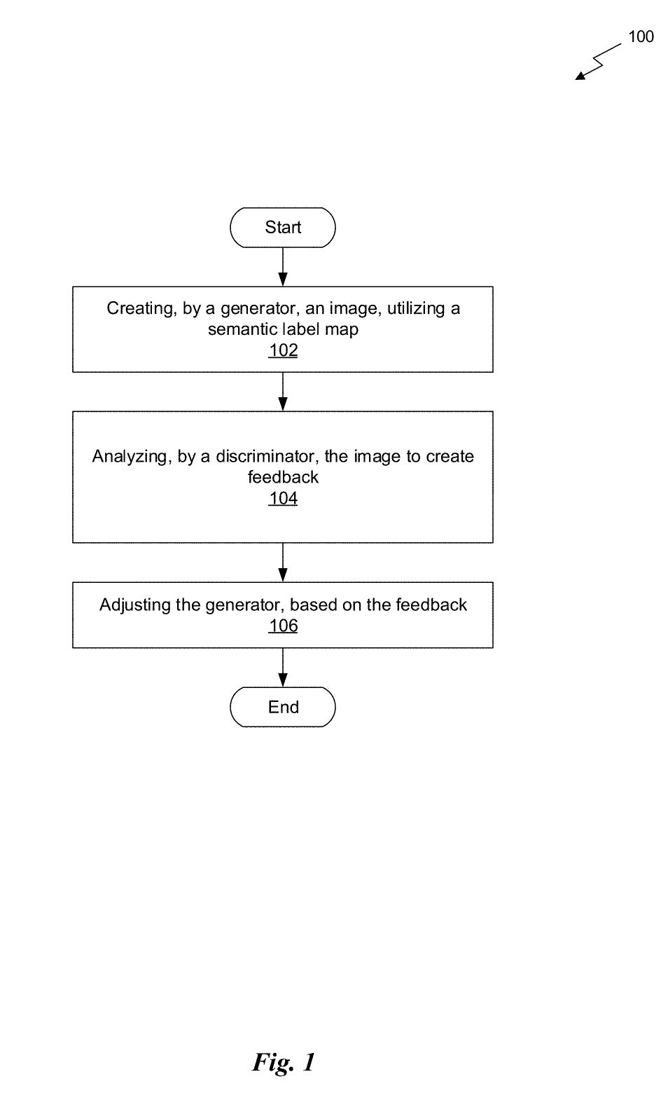

FIG. 1 illustrates a flowchart of a method 100 for creating an image utilizing a map representing object classes of pixels, in accordance with an embodiment. Although method 100 is described in the context of a processing unit, the method 100 may also be performed by a program, custom circuitry, or by a combination of custom circuitry and a program. In one embodiment, the method 100 may be executed by a GPU (graphics processing unit), CPU (central processing unit), or any processor capable of performing parallel path space filtering by hashing. Furthermore, persons of ordinary skill in the art will understand that any system that performs method 100 is within the scope and spirit of embodiments of the present invention.

As shown in operation 102, an image is created by a generator, utilizing a semantic representation. In one embodiment, the semantic representation may include a semantic label map, an edge map, a depth map, a relationship map (e.g., a relationship map between pairs of objects within an image), etc. In one embodiment, the semantic label map may include a representation of an image where each pixel of the image represents an object class that the pixel belongs to. In one embodiment, the object classes may each include an element within the image, such as a person, vehicle, sky, road, etc.

Additionally, in one embodiment, the generator may include a coarse-to-fine generator. In one embodiment, a coarse-to-fine generator may include a plurality of neural networks separate from each other that work together to create an image. In one embodiment, a first neural network within the coarse-to-fine generator may include a coarse neural network. In one embodiment, the coarse neural network may take the semantic representation as input, and may output a first image having a first resolution. In one embodiment, the coarse neural network may include a residual network that is trained on images having a first resolution.

Further, in one embodiment, a second neural network within the coarse-to-fine generator may include a fine neural network. In one embodiment, the fine neural network may take the semantic representation and the first image having the first resolution as input, and may output a second image having a second resolution greater than the first resolution as an output. In one embodiment, the input to residual blocks in the fine neural network may include an element-wise sum of a feature map of the fine neural network and an output feature map from the coarse neural network. In one embodiment, the input may include global information output from the coarse neural network as well. In one embodiment, the fine neural network may include a final network that is trained on images having a second resolution greater than the first resolution.

Further still, in one embodiment, the output of the coarse-to-fine generator may include the image output by the fine neural network. In this way, the coarse neural network may work with the fine neural network to create an image having a higher resolution when compared to a single neural network approach.

Also, in one embodiment, the creating may be performed during a training process (e.g., a training of the generator using a conditional adversarial network, etc.). In one embodiment, the generator may also use an instance feature map to create the image. In one embodiment, a separate neural network (e.g., a feature encoder network, etc.) may receive an original image on which the semantic representation is based as input, and may create an instance feature map based on the original image. In one embodiment, the instance feature map may be used as input to the generator along with the semantic representation. In one embodiment, the instance feature map may be concatenated with the semantic representation as input to the generator. In this way, the generator may utilize the instance feature map to refine the created image.

In addition, in one embodiment, the instance feature map may be used to control a style of the created image (e.g., by dictating a color and/or texture of one or more components of the created image, etc.). In one embodiment, the feature encoder network may use instance-wise average pooling to ensure that features are uniform within the instance feature map. In this way, all similar features in the created image may be the same (e.g., same color grass, same type of road, etc.).

Furthermore, as shown in operation 104, a discriminator analyzes the image to create feedback. In one embodiment, the discriminator may analyze the image by comparing the image created by the generator to an original image on which the semantic representation is based. In one embodiment, the semantic representation may be created by analyzing the original image. In one embodiment, the feedback created by the discriminator may include an indication as to whether the image created by the generator matches the original image. In one embodiment, the feedback may include one bit (e.g., where a 1 may indicate a match success, a 0 may indicate a match failure, etc.).

Further still, in one embodiment, the discriminator may include a plurality of multi-scale discriminators. In one embodiment, each of the plurality of multi-scale discriminators may include a neural network separate from the other multi-scale discriminators. In one embodiment, the image may be downsampled multiple times to create a plurality of downsampled images. In one embodiment, the image may be downsampled a first time by a first factor to create a first downsampled image having a first resolution less than a resolution of the image. In one embodiment, the image may be downsampled a second time by a second factor greater than the first factor to create a second downsampled image having a second resolution less than the first resolution and the resolution of the image.

Also, in one embodiment, each of the plurality of multi-scale discriminators may operate at an image scale different from the other discriminators, and may analyze one of the plurality of downsampled images. In one embodiment, a first discriminator may analyze the image (e.g., by comparing it to the original image). In one embodiment, a second discriminator operating at an image scale smaller than the first discriminator may analyze the first downsampled image (e.g., by comparing it to a first downsampled version of the original image having a lower resolution than the original image, etc.). In one embodiment, a third discriminator operating at an image scale smaller than the second discriminator may analyze the second downsampled image (e.g., by comparing it to a second downsampled version of the original image having a lower resolution than the first downsampled version, etc.).

Additionally, in one embodiment, each of the plurality of multi-scale discriminators may provide feedback (e.g., an indication as to whether the compared images match, etc.). In this way, the plurality of multi-scale discriminators may work together to provide more accurate feedback to the generator. In one embodiment, the discriminator may extract one or more features (e.g., intermediate feature representations, etc.) from the image created by the generator as well as the original image on which the semantic representation is based. In one embodiment, the discriminator may perform matching between the extracted features from both images.

Further, in one embodiment, the discriminator may also use the instance feature map. In one embodiment, the instance feature map created by the feature encoder network may be used as input to the discriminator along with the created image.

Further still, as shown in operation 106, the generator is adjusted, based on the feedback. In one embodiment, the generator and the discriminator may be included within a general adversarial network (GAN). In one embodiment, adjusting the generator may include changing one or more decisions made by the generator during image creation, based on the feedback. In one embodiment, the generator may be adjusted during a training process, based on the feedback. In one embodiment, the feedback may be used during the training of the generator to refine the output of the generator during the training process.

Also, in one embodiment, the adjusted generator may be used to create images based on input semantic maps. In one embodiment, the adjusted generator may identify a semantic representation, and may create a high-resolution image, utilizing the semantic representation. In one embodiment, the high-resolution image may be used by an autonomous vehicle to analyze path/road images. In one embodiment, the high-resolution image may be used by an autonomous vehicle for navigation as well as object detection within a scene.

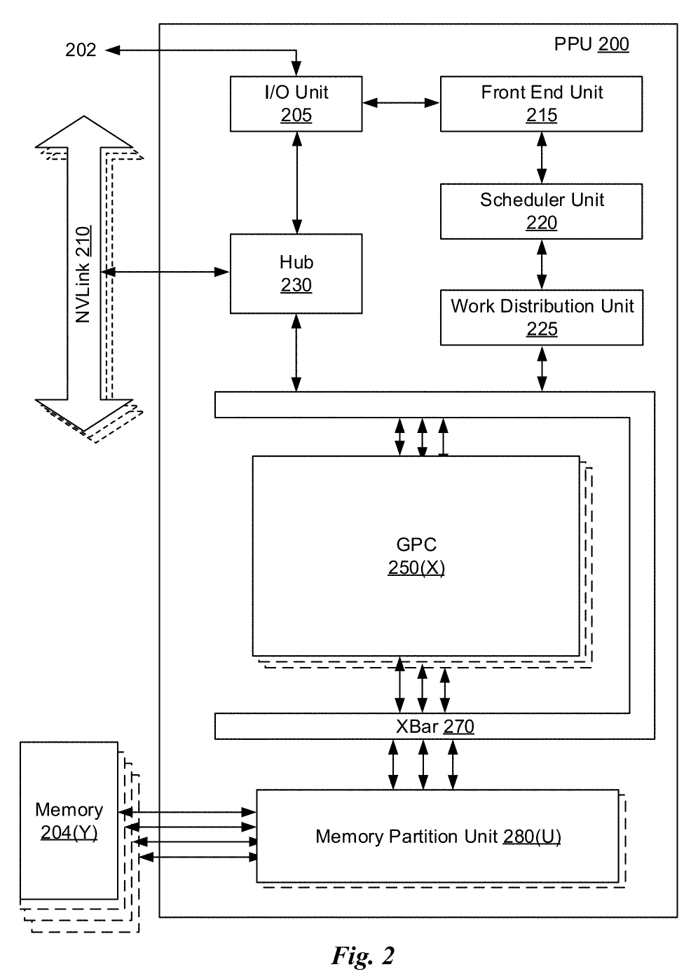

In this way, a coarse-to-fine generator may be implemented that includes a plurality of neural networks separate from each other that work together to generate the image utilizing the semantic map. Additionally, an instance feature map may be created by a separate neural network, and the instance feature map may be used by the generator and discriminator. Further, the generated images may be downsampled, and different multi-scale discriminators may be used for each of the downsampled images. Further still, intermediate feature representations may be extracted by the discriminator. Also, in one embodiment, the coarse-to-fine generator may be implemented utilizing a parallel processing unit (PPU) 200 as shown in FIG. 2 below.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

### Parallel Processing Architecture

FIG. 2 illustrates a parallel processing unit (PPU) 200, in accordance with an embodiment. In an embodiment, the PPU 200 is a multi-threaded processor that is implemented on one or more integrated circuit devices. The PPU 200 is a latency hiding architecture designed to process many threads in parallel. A thread (i.e., a thread of execution) is an instantiation of a set of instructions configured to be executed by the PPU 200. In an embodiment, the PPU 200 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the PPU 200 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more PPUs 200 may be configured to accelerate thousands of High Performance Computing (HPC), data center, and machine learning applications. The PPU 200 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 2, the PPU 200 includes an Input/Output (I/O) unit 205, a front end unit 215, a scheduler unit 220, a work distribution unit 225, a hub 230, a crossbar (Xbar) 270, one or more general processing clusters (GPCs) 250, and one or more partition units 280. The PPU 200 may be connected to a host processor or other PPUs 200 via one or more high-speed NVLink 210 interconnect. The PPU 200 may be connected to a host processor or other peripheral devices via an interconnect 202. The PPU 200 may also be connected to a local memory comprising a number of memory devices 204. In an embodiment, the local memory may comprise a number of dynamic random access memory (DRAM) devices. The DRAM devices may be configured as a high-bandwidth memory (HBM) subsystem, with multiple DRAM dies stacked within each device.

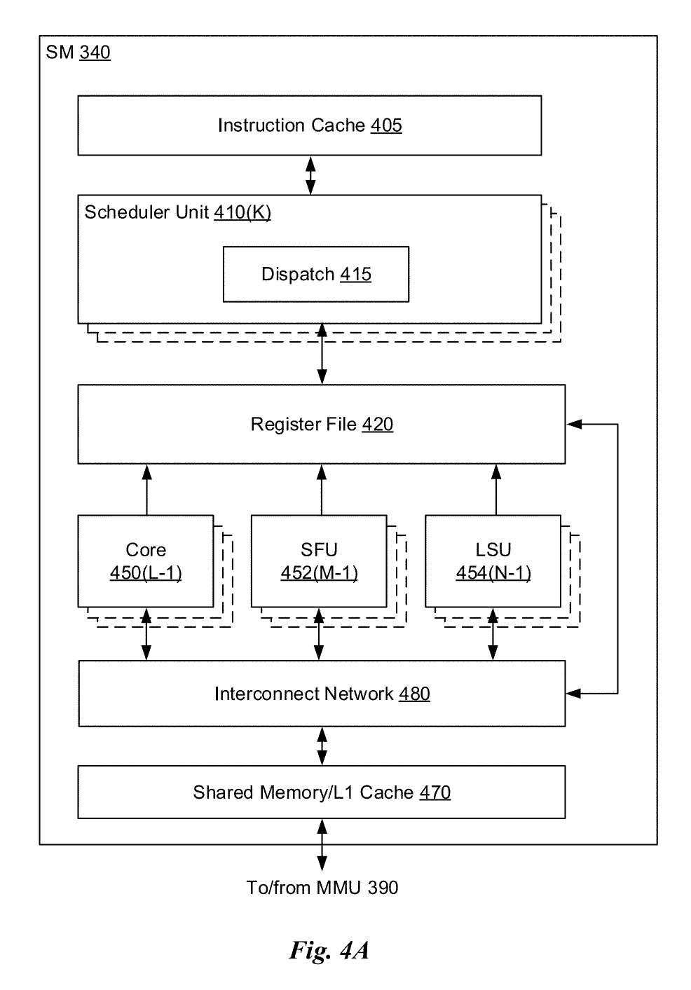

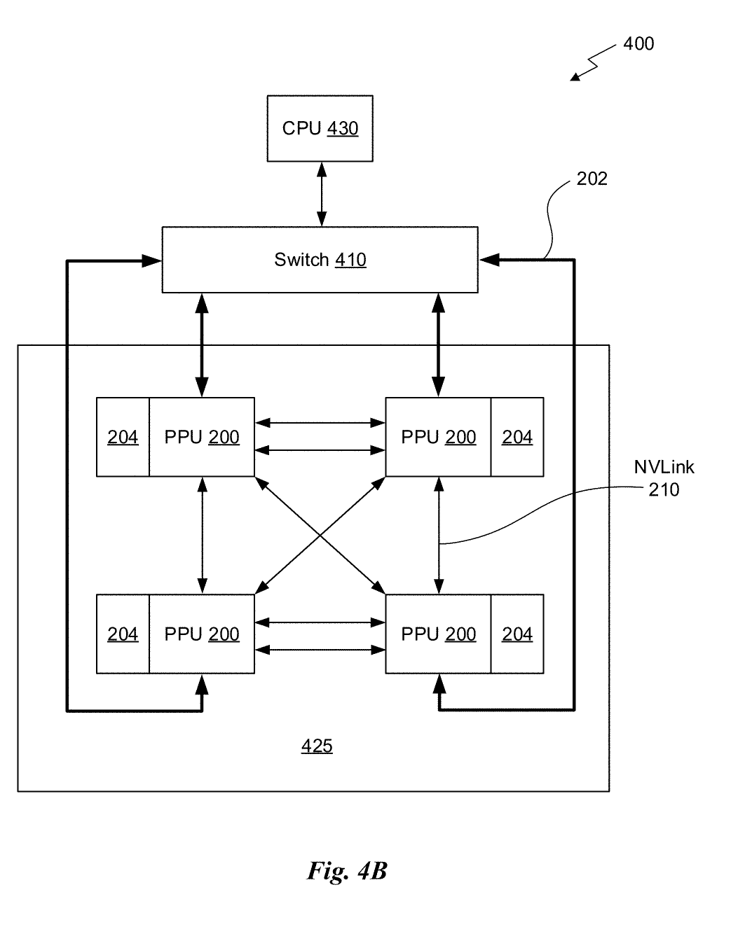

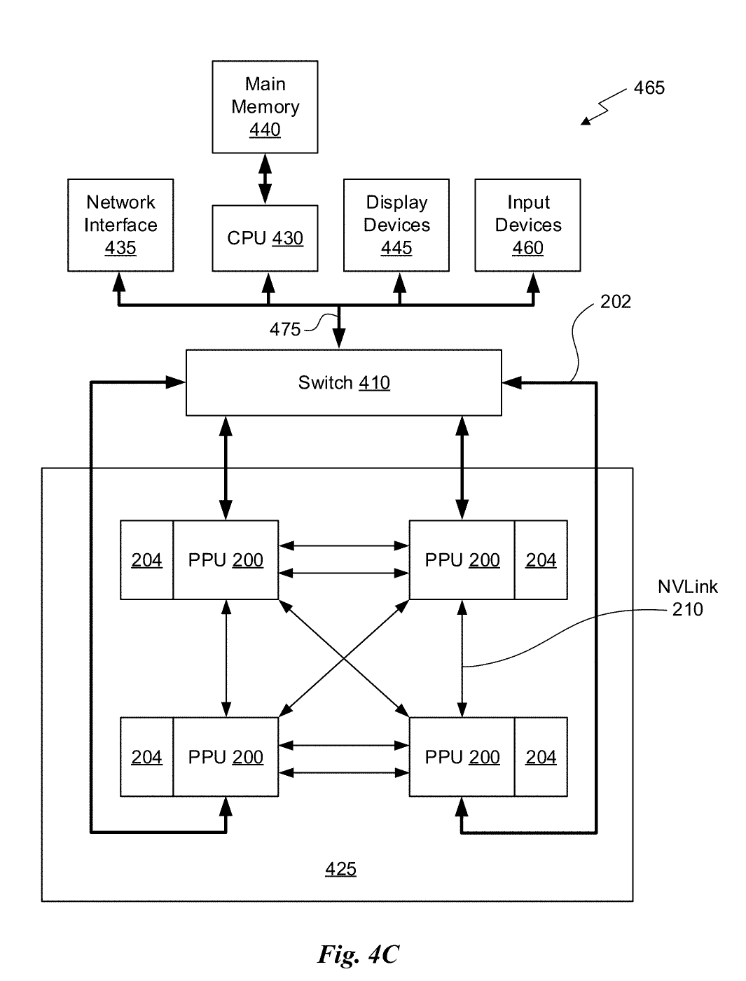

The NVLink 210 interconnect enables systems to scale and include one or more PPUs 200 combined with one or more CPUs, supports cache coherence between the PPUs 200 and CPUs, and CPU mastering. Data and/or commands may be transmitted by the NVLink 210 through the hub 230 to/from other units of the PPU 200 such as one or more copy engines, a video encoder, a video decoder, a power management unit, etc. (not explicitly shown). The NVLink 210 is described in more detail in conjunction with FIG. 4B.

The I/O unit 205 is configured to transmit and receive communications (i.e., commands, data, etc.) from a host processor (not shown) over the interconnect 202. The I/O unit 205 may communicate with the host processor directly via the interconnect 202 or through one or more intermediate devices such as a memory bridge. In an embodiment, the I/O unit 205 may communicate with one or more other processors, such as one or more the PPUs 200 via the interconnect 202. In an embodiment, the I/O unit 205 implements a Peripheral Component Interconnect Express (PCIe) interface for communications over a PCIe bus and the interconnect 202 is a PCIe bus. In alternative embodiments, the I/O unit 205 may implement other types of well-known interfaces for communicating with external devices.

The I/O unit 205 decodes packets received via the interconnect 202. In an embodiment, the packets represent commands configured to cause the PPU 200 to perform various operations. The I/O unit 205 transmits the decoded commands to various other units of the PPU 200 as the commands may specify. For example, some commands may be transmitted to the front end unit 215. Other commands may be transmitted to the hub 230 or other units of the PPU 200 such as one or more copy engines, a video encoder, a video decoder, a power management unit, etc. (not explicitly shown). In other words, the I/O unit 205 is configured to route communications between and among the various logical units of the PPU 200.

In an embodiment, a program executed by the host processor encodes a command stream in a buffer that provides workloads to the PPU 200 for processing. A workload may comprise several instructions and data to be processed by those instructions. The buffer is a region in a memory that is accessible (i.e., read/write) by both the host processor and the PPU 200. For example, the I/O unit 205 may be configured to access the buffer in a system memory connected to the interconnect 202 via memory requests transmitted over the interconnect 202. In an embodiment, the host processor writes the command stream to the buffer and then transmits a pointer to the start of the command stream to the PPU 200. The front end unit 215 receives pointers to one or more command streams. The front end unit 215 manages the one or more streams, reading commands from the streams and forwarding commands to the various units of the PPU 200.

The front end unit 215 is coupled to a scheduler unit 220 that configures the various GPCs 250 to process tasks defined by the one or more streams. The scheduler unit 220 is configured to track state information related to the various tasks managed by the scheduler unit 220. The state may indicate which GPC 250 a task is assigned to, whether the task is active or inactive, a priority level associated with the task, and so forth. The scheduler unit 220 manages the execution of a plurality of tasks on the one or more GPCs 250.

The scheduler unit 220 is coupled to a work distribution unit 225 that is configured to dispatch tasks for execution on the GPCs 250. The work distribution unit 225 may track a number of scheduled tasks received from the scheduler unit 220. In an embodiment, the work distribution unit 225 manages a pending task pool and an active task pool for each of the GPCs 250. The pending task pool may comprise a number of slots (e.g., 32 slots) that contain tasks assigned to be processed by a particular GPC 250. The active task pool may comprise a number of slots (e.g., 4 slots) for tasks that are actively being processed by the GPCs 250. As a GPC 250 finishes the execution of a task, that task is evicted from the active task pool for the GPC 250 and one of the other tasks from the pending task pool is selected and scheduled for execution on the GPC 250. If an active task has been idle on the GPC 250, such as while waiting for a data dependency to be resolved, then the active task may be evicted from the GPC 250 and returned to the pending task pool while another task in the pending task pool is selected and scheduled for execution on the GPC 250.

The work distribution unit 225 communicates with the one or more GPCs 250 via XBar 270. The XBar 270 is an interconnect network that couples many of the units of the PPU 200 to other units of the PPU 200. For example, the XBar 270 may be configured to couple the work distribution unit 225 to a particular GPC 250. Although not shown explicitly, one or more other units of the PPU 200 may also be connected to the XBar 270 via the hub 230.

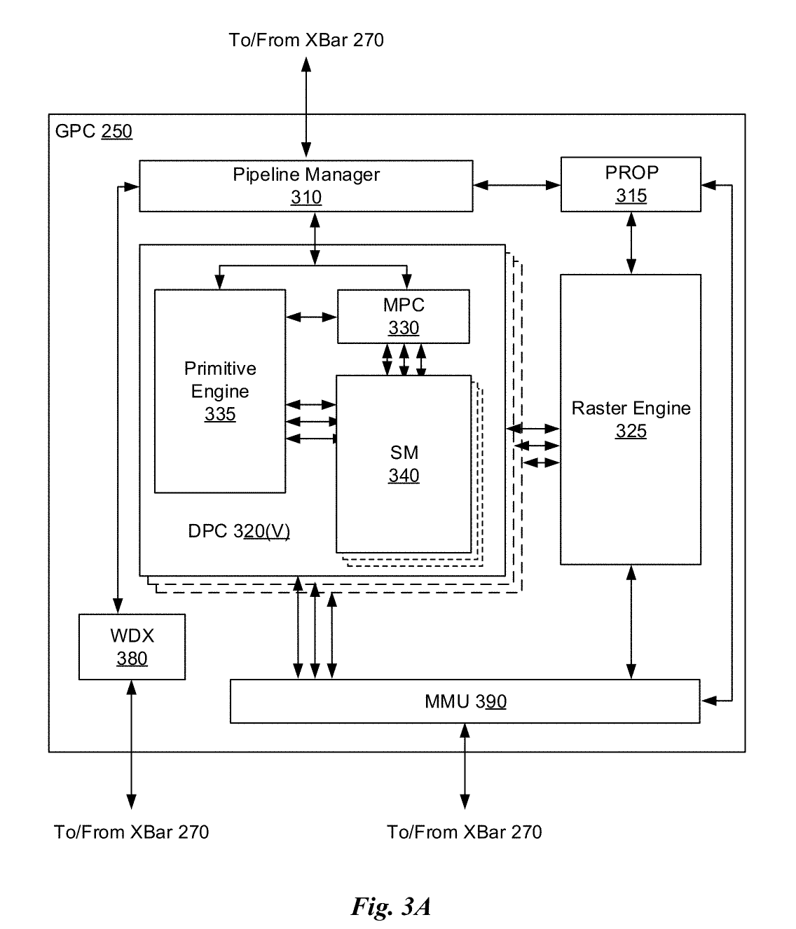

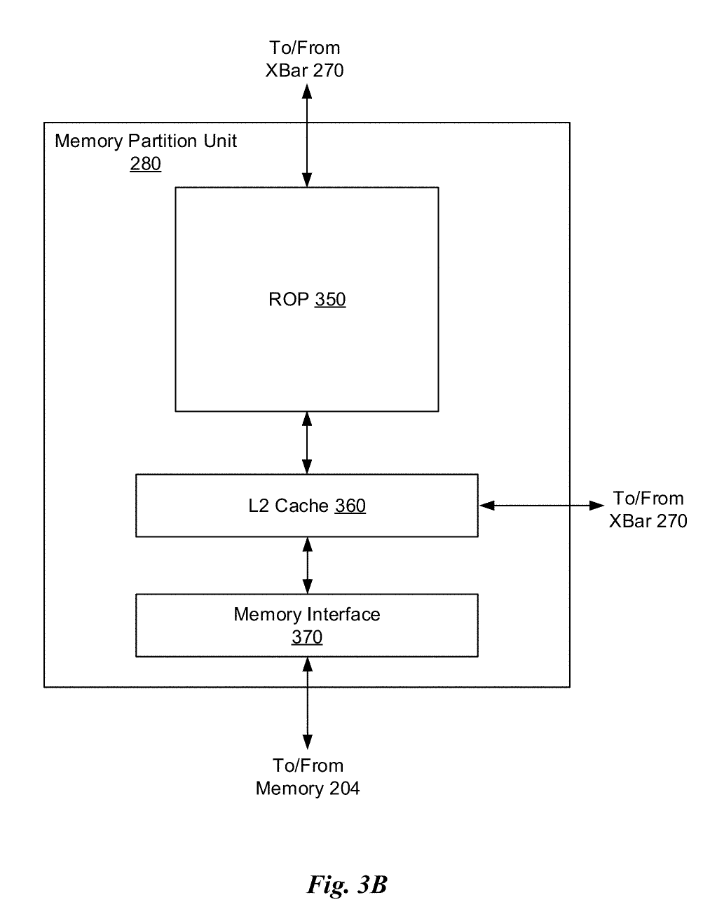

The tasks are managed by the scheduler unit 220 and dispatched to a GPC 250 by the work distribution unit 225. The GPC 250 is configured to process the task and generate results. The results may be consumed by other tasks within the GPC 250, routed to a different GPC 250 via the XBar 270, or stored in the memory 204. The results can be written to the memory 204 via the partition units 280, which implement a memory interface for reading and writing data to/from the memory 204. The results can be transmitted to another PPU 200 or CPU via the NVLink 210. In an embodiment, the PPU 200 includes a number U of partition units 280 that is equal to the number of separate and distinct memory devices 204 coupled to the PPU 200. A partition unit 280 will be described in more detail below in conjunction with FIG. 3B.

In an embodiment, a host processor executes a driver kernel that implements an application programming interface (API) that enables one or more applications executing on the host processor to schedule operations for execution on the PPU 200. In an embodiment, multiple compute applications are simultaneously executed by the PPU 200 and the PPU 200 provides isolation, quality of service (QoS), and independent address spaces for the multiple compute applications. An application may generate instructions (i.e., API calls) that cause the driver kernel to generate one or more tasks for execution by the PPU 200. The driver kernel outputs tasks to one or more streams being processed by the PPU 200. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 4A.

FIG. 3A illustrates a GPC 250 of the PPU 200 of FIG. 2, in accordance with an embodiment. As shown in FIG. 3A, each GPC 250 includes a number of hardware units for processing tasks. In an embodiment, each GPC 250 includes a pipeline manager 310, a pre-raster operations unit (PROP) 315, a raster engine 325, a work distribution crossbar (WDX) 380, a memory management unit (MMU) 390, and one or more Data Processing Clusters (DPCs) 320. It will be appreciated that the GPC 250 of FIG. 3A may include other hardware units in lieu of or in addition to the units shown in FIG. 3A.

In an embodiment, the operation of the GPC 250 is controlled by the pipeline manager 310. The pipeline manager 310 manages the configuration of the one or more DPCs 320 for processing tasks allocated to the GPC 250. In an embodiment, the pipeline manager 310 may configure at least one of the one or more DPCs 320 to implement at least a portion of a graphics rendering pipeline. For example, a DPC 320 may be configured to execute a vertex shader program on the programmable streaming multiprocessor (SM) 340. The pipeline manager 310 may also be configured to route packets received from the work distribution unit 225 to the appropriate logical units within the GPC 250. For example, some packets may be routed to fixed function hardware units in the PROP 315 and/or raster engine 325 while other packets may be routed to the DPCs 320 for processing by the primitive engine 335 or the SM 340. In an embodiment, the pipeline manager 310 may configure at least one of the one or more DPCs 320 to implement a neural network model and/or a computing pipeline.

The PROP unit 315 is configured to route data generated by the raster engine 325 and the DPCs 320 to a Raster Operations (ROP) unit, described in more detail in conjunction with FIG. 3B. The PROP unit 315 may also be configured to perform optimizations for color blending, organize pixel data, perform address translations, and the like.

The raster engine 325 includes a number of fixed function hardware units configured to perform various raster operations. In an embodiment, the raster engine 325 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x,y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 325 comprises fragments to be processed, for example, by a fragment shader implemented within a DPC 320.

Each DPC 320 included in the GPC 250 includes an M-Pipe Controller (MPC) 330, a primitive engine 335, and one or more SMs 340. The MPC 330 controls the operation of the DPC 320, routing packets received from the pipeline manager 310 to the appropriate units in the DPC 320. For example, packets associated with a vertex may be routed to the primitive engine 335, which is configured to fetch vertex attributes associated with the vertex from the memory 204. In contrast, packets associated with a shader program may be transmitted to the SM 340.

The SM 340 comprises a programmable streaming processor that is configured to process tasks represented by a number of threads. Each SM 340 is multi-threaded and configured to execute a plurality of threads (e.g., 32 threads) from a particular group of threads concurrently. In an embodiment, the SM 340 implements a SIMD (Single-Instruction, Multiple-Data) architecture where each thread in a group of threads (i.e., a warp) is configured to process a different set of data based on the same set of instructions. All threads in the group of threads execute the same instructions. In another embodiment, the SM 340 implements a SIMT (Single-Instruction, Multiple Thread) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The SM 340 will be described in more detail below in conjunction with FIG. 4A.

The MMU 390 provides an interface between the GPC 250 and the partition unit 280. The MMU 390 may provide translation of virtual addresses into physical addresses, memory protection, and arbitration of memory requests. In an embodiment, the MMU 390 provides one or more translation lookaside buffers (TLBs) for performing translation of virtual addresses into physical addresses in the memory 204.

FIG. 3B illustrates a memory partition unit 280 of the PPU 200 of FIG. 2, in accordance with an embodiment. As shown in FIG. 3B, the memory partition unit 280 includes a Raster Operations (ROP) unit 350, a level two (L2) cache 360, and a memory interface 370. The memory interface 370 is coupled to the memory 204. Memory interface 370 may implement 32, 64, 128, 1024-bit data buses, or the like, for high-speed data transfer. In an embodiment, the PPU 200 incorporates U memory interfaces 370, one memory interface 370 per pair of partition units 280, where each pair of partition units 280 is connected to a corresponding memory device 204. For example, PPU 200 may be connected to up to Y memory devices 204, such as high bandwidth memory stacks or graphics double-data-rate, version 5, synchronous dynamic random access memory, or other types of persistent storage.

In an embodiment, the memory interface 370 implements an HBM2 memory interface and Y equals half U. In an embodiment, the HBM2 memory stacks are located on the same physical package as the PPU 200, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 204 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where PPUs 200 process very large datasets and/or run applications for extended periods.

In an embodiment, the PPU 200 implements a multi-level memory hierarchy. In an embodiment, the memory partition unit 280 supports a unified memory to provide a single unified virtual address space for CPU and PPU 200 memory, enabling data sharing between virtual memory systems. In an embodiment the frequency of accesses by a PPU 200 to memory located on other processors is traced to ensure that memory pages are moved to the physical memory of the PPU 200 that is accessing the pages more frequently. In an embodiment, the NVLink 210 supports address translation services allowing the PPU 200 to directly access a CPU's page tables and providing full access to CPU memory by the PPU 200.

In an embodiment, copy engines transfer data between multiple PPUs 200 or between PPUs 200 and CPUs. The copy engines can generate page faults for addresses that are not mapped into the page tables. The memory partition unit 280 can then service the page faults, mapping the addresses into the page table, after which the copy engine can perform the transfer. In a conventional system, memory is pinned (i.e., non-pageable) for multiple copy engine operations between multiple processors, substantially reducing the available memory. With hardware page faulting, addresses can be passed to the copy engines without worrying if the memory pages are resident, and the copy process is transparent.

Data from the memory 204 or other system memory may be fetched by the memory partition unit 280 and stored in the L2 cache 360, which is located on-chip and is shared between the various GPCs 250. As shown, each memory partition unit 280 includes a portion of the L2 cache 360 associated with a corresponding memory device 204. Lower level caches may then be implemented in various units within the GPCs 250. For example, each of the SMs 340 may implement a level one (L1) cache. The L1 cache is private memory that is dedicated to a particular SM 340. Data from the L2 cache 360 may be fetched and stored in each of the L1 caches for processing in the functional units of the SMs 340. The L2 cache 360 is coupled to the memory interface 370 and the XBar 270.

The ROP unit 350 performs graphics raster operations related to pixel color, such as color compression, pixel blending, and the like. The ROP unit 350 also implements depth testing in conjunction with the raster engine 325, receiving a depth for a sample location associated with a pixel fragment from the culling engine of the raster engine 325. The depth is tested against a corresponding depth in a depth buffer for a sample location associated with the fragment. If the fragment passes the depth test for the sample location, then the ROP unit 350 updates the depth buffer and transmits a result of the depth test to the raster engine 325. It will be appreciated that the number of partition units 280 may be different than the number of GPCs 250 and, therefore, each ROP unit 350 may be coupled to each of the GPCs 250. The ROP unit 350 tracks packets received from the different GPCs 250 and determines which GPC 250 that a result generated by the ROP unit 350 is routed to through the Xbar 270. Although the ROP unit 350 is included within the memory partition unit 280 in FIG. 3B, in other embodiment, the ROP unit 350 may be outside of the memory partition unit 280. For example, the ROP unit 350 may reside in the GPC 250 or another unit.

FIG. 4A illustrates the streaming multi-processor 340 of FIG. 3A, in accordance with an embodiment. As shown in FIG. 4A, the SM 340 includes an instruction cache 405, one or more scheduler units 410(K), a register file 420, one or more processing cores 450, one or more special function units (SFUs) 452, one or more load/store units (LSUs) 454, an interconnect network 480, a shared memory/L1 cache 470.

As described above, the work distribution unit 225 dispatches tasks for execution on the GPCs 250 of the PPU 200. The tasks are allocated to a particular DPC 320 within a GPC 250 and, if the task is associated with a shader program, the task may be allocated to an SM 340. The scheduler unit 410(K) receives the tasks from the work distribution unit 225 and manages instruction scheduling for one or more thread blocks assigned to the SM 340. The scheduler unit 410(K) schedules thread blocks for execution as warps of parallel threads, where each thread block is allocated at least one warp. In an embodiment, each warp executes 32 threads. The scheduler unit 410(K) may manage a plurality of different thread blocks, allocating the warps to the different thread blocks and then dispatching instructions from the plurality of different cooperative groups to the various functional units (i.e., cores 450, SFUs 452, and LSUs 454) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (i.e., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (i.e., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch unit 415 is configured to transmit instructions to one or more of the functional units. In the embodiment, the scheduler unit 410(K) includes two dispatch units 415 that enable two different instructions from the same warp to be dispatched during each clock cycle. In alternative embodiments, each scheduler unit 410(K) may include a single dispatch unit 415 or additional dispatch units 415.

Each SM 340 includes a register file 420 that provides a set of registers for the functional units of the SM 340. In an embodiment, the register file 420 is divided between each of the functional units such that each functional unit is allocated a dedicated portion of the register file 420. In another embodiment, the register file 420 is divided between the different warps being executed by the SM 340. The register file 420 provides temporary storage for operands connected to the data paths of the functional units.

Each SM 340 comprises L processing cores 450. In an embodiment, the SM 340 includes a large number (e.g., 128, etc.) of distinct processing cores 450. Each core 450 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the cores 450 include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the cores 450. In particular, the tensor cores are configured to perform deep learning matrix arithmetic, such as convolution operations for neural network training and inferencing. In an embodiment, each tensor core operates on a 4×4 matrix and performs a matrix multiply and accumulate operation D=A×B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each SM 340 also comprises M SFUs 452 that perform special functions (e.g., attribute evaluation, reciprocal square root, and the like). In an embodiment, the SFUs 452 may include a tree traversal unit configured to traverse a hierarchical tree data structure. In an embodiment, the SFUs 452 may include texture unit configured to perform texture map filtering operations. In an embodiment, the texture units are configured to load texture maps (e.g., a 2D array of texels) from the memory 204 and sample the texture maps to produce sampled texture values for use in shader programs executed by the SM 340. In an embodiment, the texture maps are stored in the shared memory/L1 cache 370. The texture units implement texture operations such as filtering operations using mip-maps (i.e., texture maps of varying levels of detail). In an embodiment, each SM 240 includes two texture units.

Each SM 340 also comprises N LSUs 454 that implement load and store operations between the shared memory/L1 cache 470 and the register file 420. Each SM 340 includes an interconnect network 480 that connects each of the functional units to the register file 420 and the LSU 454 to the register file 420, shared memory/L1 cache 470. In an embodiment, the interconnect network 480 is a crossbar that can be configured to connect any of the functional units to any of the registers in the register file 420 and connect the LSUs 454 to the register file and memory locations in shared memory/L1 cache 470.

The shared memory/L1 cache 470 is an array of on-chip memory that allows for data storage and communication between the SM 340 and the primitive engine 335 and between threads in the SM 340. In an embodiment, the shared memory/L1 cache 470 comprises 128 KB of storage capacity and is in the path from the SM 340 to the partition unit 280. The shared memory/L1 cache 470 can be used to cache reads and writes. One or more of the shared memory/L1 cache 470, L2 cache 360, and memory 204 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 470 enables the shared memory/L1 cache 470 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 2, are bypassed, creating a much simpler programming model. In the general purpose parallel computation configuration, the work distribution unit 225 assigns and distributes blocks of threads directly to the DPCs 320. The threads in a block execute the same program, using a unique thread ID in the calculation to ensure each thread generates unique results, using the SM 340 to execute the program and perform calculations, shared memory/L1 cache 470 to communicate between threads, and the LSU 454 to read and write global memory through the shared memory/L1 cache 470 and the memory partition unit 280. When configured for general purpose parallel computation, the SM 340 can also write commands that the scheduler unit 220 can use to launch new work on the DPCs 320.

The PPU 200 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the PPU 200 is embodied on a single semiconductor substrate. In another embodiment, the PPU 200 is included in a system-on-a-chip (SoC) along with one or more other devices such as additional PPUs 200, the memory 204, a reduced instruction set computer (RISC) CPU, a memory management unit (MMU), a digital-to-analog converter (DAC), and the like.

In an embodiment, the PPU 200 may be included on a graphics card that includes one or more memory devices 204. The graphics card may be configured to interface with a PCIe slot on a motherboard of a desktop computer. In yet another embodiment, the PPU 200 may be an integrated graphics processing unit (iGPU) or parallel processor included in the chipset of the motherboard.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 4B is a conceptual diagram of a processing system 400 implemented using the PPU 200 of FIG. 2, in accordance with an embodiment. The exemplary system 465 may be configured to implement the method 100 shown in FIG. 1. The processing system 400 includes a CPU 430, switch 410, and multiple PPUs 200 each and respective memories 204. The NVLink 210 provides high-speed communication links between each of the PPUs 200. Although a particular number of NVLink 210 and interconnect 202 connections are illustrated in FIG. 4B, the number of connections to each PPU 200 and the CPU 430 may vary. The switch 410 interfaces between the interconnect 202 and the CPU 430. The PPUs 200, memories 204, and NVLinks 210 may be situated on a single semiconductor platform to form a parallel processing module 425. In an embodiment, the switch 410 supports two or more protocols to interface between various different connections and/or links.

In another embodiment (not shown), the NVLink 210 provides one or more high-speed communication links between each of the PPUs 200 and the CPU 430 and the switch 410 interfaces between the interconnect 202 and each of the PPUs 200. The PPUs 200, memories 204, and interconnect 202 may be situated on a single semiconductor platform to form a parallel processing module 425. In yet another embodiment (not shown), the interconnect 202 provides one or more communication links between each of the PPUs 200 and the CPU 430 and the switch 410 interfaces between each of the PPUs 200 using the NVLink 210 to provide one or more high-speed communication links between the PPUs 200. In another embodiment (not shown), the NVLink 210 provides one or more high-speed communication links between the PPUs 200 and the CPU 430 through the switch 410. In yet another embodiment (not shown), the interconnect 202 provides one or more communication links between each of the PPUs 200 directly. One or more of the NVLink 210 high-speed communication links may be implemented as a physical NVLink interconnect or either an on-chip or on-die interconnect using the same protocol as the NVLink 210.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 425 may be implemented as a circuit board substrate and each of the PPUs 200 and/or memories 204 may be packaged devices. In an embodiment, the CPU 430, switch 410, and the parallel processing module 425 are situated on a single semiconductor platform.

In an embodiment, the signaling rate of each NVLink 210 is 20 to 25 Gigabits/second and each PPU 200 includes six NVLink 210 interfaces (as shown in FIG. 4B, five NVLink 210 interfaces are included for each PPU 200). Each NVLink 210 provides a data transfer rate of 25 Gigabytes/second in each direction, with six links providing 300 Gigabytes/second. The NVLinks 210 can be used exclusively for PPU-to-PPU communication as shown in FIG. 4B, or some combination of PPU-to-PPU and PPU-to-CPU, when the CPU 430 also includes one or more NVLink 210 interfaces.

In an embodiment, the NVLink 210 allows direct load/store/atomic access from the CPU 430 to each PPU's 200 memory 204. In an embodiment, the NVLink 210 supports coherency operations, allowing data read from the memories 204 to be stored in the cache hierarchy of the CPU 430, reducing cache access latency for the CPU 430. In an embodiment, the NVLink 210 includes support for Address Translation Services (ATS), allowing the PPU 200 to directly access page tables within the CPU 430. One or more of the NVLinks 210 may also be configured to operate in a low-power mode.

FIG. 4C illustrates an exemplary system 465 in which the various architecture and/or functionality of the various previous embodiments may be implemented. The exemplary system 465 may be configured to implement the method 100 shown in FIG. 1.

As shown, a system 465 is provided including at least one central processing unit 430 that is connected to a communication bus 475. The communication bus 475 may be implemented using any suitable protocol, such as PCI (Peripheral Component Interconnect), PCI-Express, AGP (Accelerated Graphics Port), HyperTransport, or any other bus or point-to-point communication protocol(s). The system 465 also includes a main memory 440. Control logic (software) and data are stored in the main memory 440 which may take the form of random access memory (RAM).

The system 465 also includes input devices 460, the parallel processing system 425, and display devices 445, i.e. a conventional CRT (cathode ray tube), LCD (liquid crystal display), LED (light emitting diode), plasma display or the like. User input may be received from the input devices 460, e.g., keyboard, mouse, touchpad, microphone, and the like. Each of the foregoing modules and/or devices may even be situated on a single semiconductor platform to form the system 465. Alternately, the various modules may also be situated separately or in various combinations of semiconductor platforms per the desires of the user.

Further, the system 465 may be coupled to a network (e.g., a telecommunications network, local area network (LAN), wireless network, wide area network (WAN) such as the Internet, peer-to-peer network, cable network, or the like) through a network interface 435 for communication purposes.

The system 465 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 440 and/or the secondary storage. Such computer programs, when executed, enable the system 465 to perform various functions. The memory 440, the storage, and/or any other storage are possible examples of computer-readable media.

The architecture and/or functionality of the various previous figures may be implemented in the context of a general computer system, a circuit board system, a game console system dedicated for entertainment purposes, an application-specific system, and/or any other desired system. For example, the system 465 may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Graphics Processing Pipeline

In an embodiment, the PPU 200 comprises a graphics processing unit (GPU). The PPU 200 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 200 can be configured to process the graphics primitives to generate a frame buffer (i.e., pixel data for each of the pixels of the display).

An application writes model data for a scene (i.e., a collection of vertices and attributes) to a memory such as a system memory or memory 204. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the SMs 340 of the PPU 200 including one or more of a vertex shader, hull shader, domain shader, geometry shader, and a pixel shader. For example, one or more of the SMs 340 may be configured to execute a vertex shader program that processes a number of vertices defined by the model data. In an embodiment, the different SMs 340 may be configured to execute different shader programs concurrently. For example, a first subset of SMs 340 may be configured to execute a vertex shader program while a second subset of SMs 340 may be configured to execute a pixel shader program. The first subset of SMs 340 processes vertex data to produce processed vertex data and writes the processed vertex data to the L2 cache 360 and/or the memory 204. After the processed vertex data is rasterized (i.e., transformed from three-dimensional data into two-dimensional data in screen space) to produce fragment data, the second subset of SMs 340 executes a pixel shader to produce processed fragment data, which is then blended with other processed fragment data and written to the frame buffer in memory 204. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

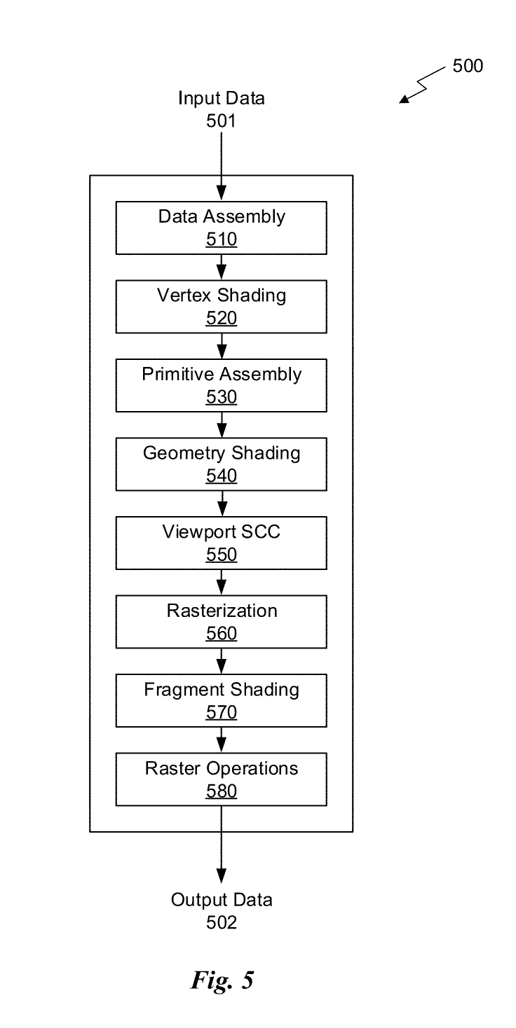

FIG. 5 is a conceptual diagram of a graphics processing pipeline 500 implemented by the PPU 200 of FIG. 2, in accordance with an embodiment. The graphics processing pipeline 500 is an abstract flow diagram of the processing steps implemented to generate 2D computer-generated images from 3D geometry data. As is well-known, pipeline architectures may perform long latency operations more efficiently by splitting up the operation into a plurality of stages, where the output of each stage is coupled to the input of the next successive stage. Thus, the graphics processing pipeline 500 receives input data 501 that is transmitted from one stage to the next stage of the graphics processing pipeline 500 to generate output data 502. In an embodiment, the graphics processing pipeline 500 may represent a graphics processing pipeline defined by the OpenGL® API. As an option, the graphics processing pipeline 500 may be implemented in the context of the functionality and architecture of the previous Figures and/or any subsequent Figure(s).

As shown in FIG. 5, the graphics processing pipeline 500 comprises a pipeline architecture that includes a number of stages. The stages include, but are not limited to, a data assembly stage 510, a vertex shading stage 520, a primitive assembly stage 530, a geometry shading stage 540, a viewport scale, cull, and clip (VSCC) stage 550, a rasterization stage 560, a fragment shading stage 570, and a raster operations stage 580. In an embodiment, the input data 501 comprises commands that configure the processing units to implement the stages of the graphics processing pipeline 500 and geometric primitives (e.g., points, lines, triangles, quads, triangle strips or fans, etc.) to be processed by the stages. The output data 502 may comprise pixel data (i.e., color data) that is copied into a frame buffer or other type of surface data structure in a memory.

The data assembly stage 510 receives the input data 501 that specifies vertex data for high-order surfaces, primitives, or the like. The data assembly stage 510 collects the vertex data in a temporary storage or queue, such as by receiving a command from the host processor that includes a pointer to a buffer in memory and reading the vertex data from the buffer. The vertex data is then transmitted to the vertex shading stage 520 for processing.

The vertex shading stage 520 processes vertex data by performing a set of operations (i.e., a vertex shader or a program) once for each of the vertices. Vertices may be, e.g., specified as a 4-coordinate vector (i.e., <x, y, z, w>) associated with one or more vertex attributes (e.g., color, texture coordinates, surface normal, etc.). The vertex shading stage 520 may manipulate individual vertex attributes such as position, color, texture coordinates, and the like. In other words, the vertex shading stage 520 performs operations on the vertex coordinates or other vertex attributes associated with a vertex. Such operations commonly including lighting operations (i.e., modifying color attributes for a vertex) and transformation operations (i.e., modifying the coordinate space for a vertex). For example, vertices may be specified using coordinates in an object-coordinate space, which are transformed by multiplying the coordinates by a matrix that translates the coordinates from the object-coordinate space into a world space or a normalized-device-coordinate (NCD) space. The vertex shading stage 520 generates transformed vertex data that is transmitted to the primitive assembly stage 530.

The primitive assembly stage 530 collects vertices output by the vertex shading stage 520 and groups the vertices into geometric primitives for processing by the geometry shading stage 540. For example, the primitive assembly stage 530 may be configured to group every three consecutive vertices as a geometric primitive (i.e., a triangle) for transmission to the geometry shading stage 540. In some embodiments, specific vertices may be reused for consecutive geometric primitives (e.g., two consecutive triangles in a triangle strip may share two vertices). The primitive assembly stage 530 transmits geometric primitives (i.e., a collection of associated vertices) to the geometry shading stage 540.

The geometry shading stage 540 processes geometric primitives by performing a set of operations (i.e., a geometry shader or program) on the geometric primitives. Tessellation operations may generate one or more geometric primitives from each geometric primitive. In other words, the geometry shading stage 540 may subdivide each geometric primitive into a finer mesh of two or more geometric primitives for processing by the rest of the graphics processing pipeline 500. The geometry shading stage 540 transmits geometric primitives to the viewport SCC stage 550.

In an embodiment, the graphics processing pipeline 500 may operate within a streaming multiprocessor and the vertex shading stage 520, the primitive assembly stage 530, the geometry shading stage 540, the fragment shading stage 570, and/or hardware/software associated therewith, may sequentially perform processing operations. Once the sequential processing operations are complete, in an embodiment, the viewport SCC stage 550 may utilize the data. In an embodiment, primitive data processed by one or more of the stages in the graphics processing pipeline 500 may be written to a cache (e.g. L1 cache, a vertex cache, etc.). In this case, in an embodiment, the viewport SCC stage 550 may access the data in the cache. In an embodiment, the viewport SCC stage 550 and the rasterization stage 560 are implemented as fixed function circuitry.

The viewport SCC stage 550 performs viewport scaling, culling, and clipping of the geometric primitives. Each surface being rendered to is associated with an abstract camera position. The camera position represents a location of a viewer looking at the scene and defines a viewing frustum that encloses the objects of the scene. The viewing frustum may include a viewing plane, a rear plane, and four clipping planes. Any geometric primitive entirely outside of the viewing frustum may be culled (i.e., discarded) because the geometric primitive will not contribute to the final rendered scene. Any geometric primitive that is partially inside the viewing frustum and partially outside the viewing frustum may be clipped (i.e., transformed into a new geometric primitive that is enclosed within the viewing frustum. Furthermore, geometric primitives may each be scaled based on a depth of the viewing frustum. All potentially visible geometric primitives are then transmitted to the rasterization stage 560.

The rasterization stage 560 converts the 3D geometric primitives into 2D fragments (e.g. capable of being utilized for display, etc.). The rasterization stage 560 may be configured to utilize the vertices of the geometric primitives to setup a set of plane equations from which various attributes can be interpolated. The rasterization stage 560 may also compute a coverage mask for a plurality of pixels that indicates whether one or more sample locations for the pixel intercept the geometric primitive. In an embodiment, z-testing may also be performed to determine if the geometric primitive is occluded by other geometric primitives that have already been rasterized. The rasterization stage 560 generates fragment data (i.e., interpolated vertex attributes associated with a particular sample location for each covered pixel) that are transmitted to the fragment shading stage 570.

The fragment shading stage 570 processes fragment data by performing a set of operations (i.e., a fragment shader or a program) on each of the fragments. The fragment shading stage 570 may generate pixel data (i.e., color values) for the fragment such as by performing lighting operations or sampling texture maps using interpolated texture coordinates for the fragment. The fragment shading stage 570 generates pixel data that is transmitted to the raster operations stage 580.

The raster operations stage 580 may perform various operations on the pixel data such as performing alpha tests, stencil tests, and blending the pixel data with other pixel data corresponding to other fragments associated with the pixel. When the raster operations stage 580 has finished processing the pixel data (i.e., the output data 502), the pixel data may be written to a render target such as a frame buffer, a color buffer, or the like.

It will be appreciated that one or more additional stages may be included in the graphics processing pipeline 500 in addition to or in lieu of one or more of the stages described above. Various implementations of the abstract graphics processing pipeline may implement different stages. Furthermore, one or more of the stages described above may be excluded from the graphics processing pipeline in some embodiments (such as the geometry shading stage 540). Other types of graphics processing pipelines are contemplated as being within the scope of the present disclosure. Furthermore, any of the stages of the graphics processing pipeline 500 may be implemented by one or more dedicated hardware units within a graphics processor such as PPU 200. Other stages of the graphics processing pipeline 500 may be implemented by programmable hardware units such as the SM 340 of the PPU 200.

The graphics processing pipeline 500 may be implemented via an application executed by a host processor, such as a CPU. In an embodiment, a device driver may implement an application programming interface (API) that defines various functions that can be utilized by an application in order to generate graphical data for display. The device driver is a software program that includes a plurality of instructions that control the operation of the PPU 200. The API provides an abstraction for a programmer that lets a programmer utilize specialized graphics hardware, such as the PPU 200, to generate the graphical data without requiring the programmer to utilize the specific instruction set for the PPU 200. The application may include an API call that is routed to the device driver for the PPU 200. The device driver interprets the API call and performs various operations to respond to the API call. In some instances, the device driver may perform operations by executing instructions on the CPU. In other instances, the device driver may perform operations, at least in part, by launching operations on the PPU 200 utilizing an input/output interface between the CPU and the PPU 200. In an embodiment, the device driver is configured to implement the graphics processing pipeline 500 utilizing the hardware of the PPU 200.

Various programs may be executed within the PPU 200 in order to implement the various stages of the graphics processing pipeline 500. For example, the device driver may launch a kernel on the PPU 200 to perform the vertex shading stage 520 on one SM 340 (or multiple SMs 340). The device driver (or the initial kernel executed by the PPU 300) may also launch other kernels on the PPU 300 to perform other stages of the graphics processing pipeline 500, such as the geometry shading stage 540 and the fragment shading stage 570. In addition, some of the stages of the graphics processing pipeline 500 may be implemented on fixed unit hardware such as a rasterizer or a data assembler implemented within the PPU 300. It will be appreciated that results from one kernel may be processed by one or more intervening fixed function hardware units before being processed by a subsequent kernel on an SM 340.

### Machine Learning

Deep neural networks (DNNs) developed on processors, such as the PPU 200 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 200. Inferencing is less compute-intensive than training, being a latency-sensitive process where a trained neural network is applied to new inputs it has not seen before to classify images, translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 200 is a computing platform capable of delivering performance required for deep neural network-based artificial intelligence and machine learning applications.

### High-Resolution Image Synthesis and Semantic Manipulation with Conditional GANs

In one embodiment, high resolution photo-realistic images may be synthesized from semantic label maps using conditional adversarial networks (conditional GANs). Conditional GANs have enabled a variety of applications, but the results are often limited to low-resolution and are still far from realistic. In one embodiment, high-resolution, visually appealing results may be generated with a novel adversarial objective, as well as new multiscale generator and discriminator architectures. In one embodiment, an image synthesis pipeline may be extended to interactive visual manipulation with two additional features, including (1) the incorporation of instance-level segmentation information, which enables object manipulations such as removing/adding objects and changing the object category, and (2) a method to generate diverse results given the same input label map, allowing the user to interactively edit the appearance of each object. This implementation significantly outperforms existing methods, advancing both the quality and the resolution of deep image synthesis.

Introduction

Rendering photo-realistic images using standard graphics techniques is involved, since geometry, materials and light transport must be simulated explicitly. Although existing graphics algorithms excel at the task, building and editing virtual environments is expensive and time-consuming. That is because we have to model each part of the world explicitly. If we were able to render photo-realistic images using a model learned from data, we could turn the process of rendering graphics into a model learning and inference problem. Then, we could simplify the process of creating new virtual worlds by training models on new datasets. We could even make it easier to customize environments by allowing users to simply specify semantic information rather than modeling geometry, materials, or lighting.

In one embodiment, a new approach may produce high-resolution images from semantic label maps. This method has a wide range of applications. In one embodiment, it may be used to create synthetic training data for training visual recognition networks, since it is much easier to create semantic labels for desired scenarios than to generate training images. Using semantic segmentation, images may be transformed into a semantic label domain, the objects may be edited in the label domain, and then the objects may be transformed back to the image domain. New tools may therefore be provided for higher-level image editing, e.g., adding objects to images or changing the appearance of existing objects.

In one embodiment, two issues may be addressed: (1) the difficulty of generating high-resolution images with conditional GANs and (2) lack of details and realistic textures in previous high-res results. With a new robust adversarial learning objective as well as new multi-scale generator and discriminator architectures, we can synthesize photo-realistic images at high resolution (e.g., 2048×1024 resolution, etc.), as well as achieve more visually appealing results compared to previous methods. We first obtain our results with adversarial training only, without relying on any hand-crafted losses or pre-trained networks. Then we show that adding perceptual losses from pre-trained networks can slightly improve the results in some circumstances, if a pre-trained network is available. Both results outperform previous work substantially in terms of image quality.

Furthermore, in one embodiment, to support interactive semantic manipulation, we enhance our method with two extensions: first, we leverage instance-level segmentation information to improve the quality of generated images as well as enable flexible object manipulations, such as removing/adding objects and changing object types. Second, we propose a method to generate diverse results given the same input label, allowing a user to edit the appearance of the same object interactively. We compare against state-of-the-art visual synthesis systems and show that our method outperforms these approaches regarding both quantitative evaluations and human perception studies. We also perform an ablation study regarding the design of our network and the importance of instance-level segmentation information.

Generative Adversarial Networks

In one embodiment, generative adversarial networks (GANs) aim to model the natural image manifold by forcing the generated samples to be indistinguishable from natural images. GANs enable a wide variety of applications such as image generation, representation learning, and image manipulation. Various coarse-to-fine schemes have been proposed to synthesize larger images (e.g. 256×256) in an unconditional setting. In one embodiment, we propose a coarse-to-fine objective function as well as new multiscale generator and discriminator architectures suitable for conditional image generation at a much higher resolution.

Instance-Level Image Synthesis

In one embodiment, we propose a conditional adversarial framework for creating high-resolution photorealistic images from semantic label maps. We first briefly review our baseline model pix2pix. We then describe how we increase the photorealism and resolution of the synthesized results with our improved objective function and network design. Next, we show how we use the additional instance-level semantic information to further improve the image quality. Finally, we will introduce an instance-level feature embedding scheme to better handle the multi-modal nature of image synthesis, which enables interactive object editing.

The pix2pix Baseline

In one embodiment, the pix2pix framework includes a conditional GAN framework for image-to-image translation. It consists of a generator and a discriminator. In one embodiment, the objective of the generator is to translate semantic label maps to realistic looking images, while the objective of the discriminator is to distinguish real images from the translated ones. In one embodiment, the framework operates in a supervised setting. In other words, the training dataset is given as a set of pairs of corresponding images {(sᵢ, xᵢ)}, where sᵢ is a semantic label map and xᵢ is a corresponding natural photo. In one embodiment, conditional GANs aim to model the conditional distribution of real images given the input semantic label map Pr(S|X), where S is the space of semantic label maps and X is the space of real images, via solving:

$${max}_{G} {min}_{D} {ℒ}_{GAN} ( G , D ) \qquad ( 1 )$$

where the objective function [symbol] _{GAN}(G, D) is given by:

[symbol]

_{(s,x)}[−log D(s,x)]+ [symbol] [−log(1−D(s,G(s))] (2)

In one embodiment, in pix2pix, the generator is implemented as a U-Net auto-encoder and the discriminator is implemented as a patch-based discriminator. The input to the discriminator is the channel-wise concatenation of the semantic label map and the corresponding image. The resolution of the generated images is up to 256×256. In one embodiment, the pix2pix framework may be improved, as described below.

Improving Photorealism and Resolution

In one embodiment, the pix2pix framework may be improved by using a new generator architecture, a new discriminator architecture, and a new learning objective function.

Coarse-to-Fine Generator

In one embodiment, we decompose the generator into two sub-networks: G₀ and G₁. We term G₀ as the global generator network and G₁ as the local enhancer network. The generator is then given by the tuple G={G₀; G₁}.

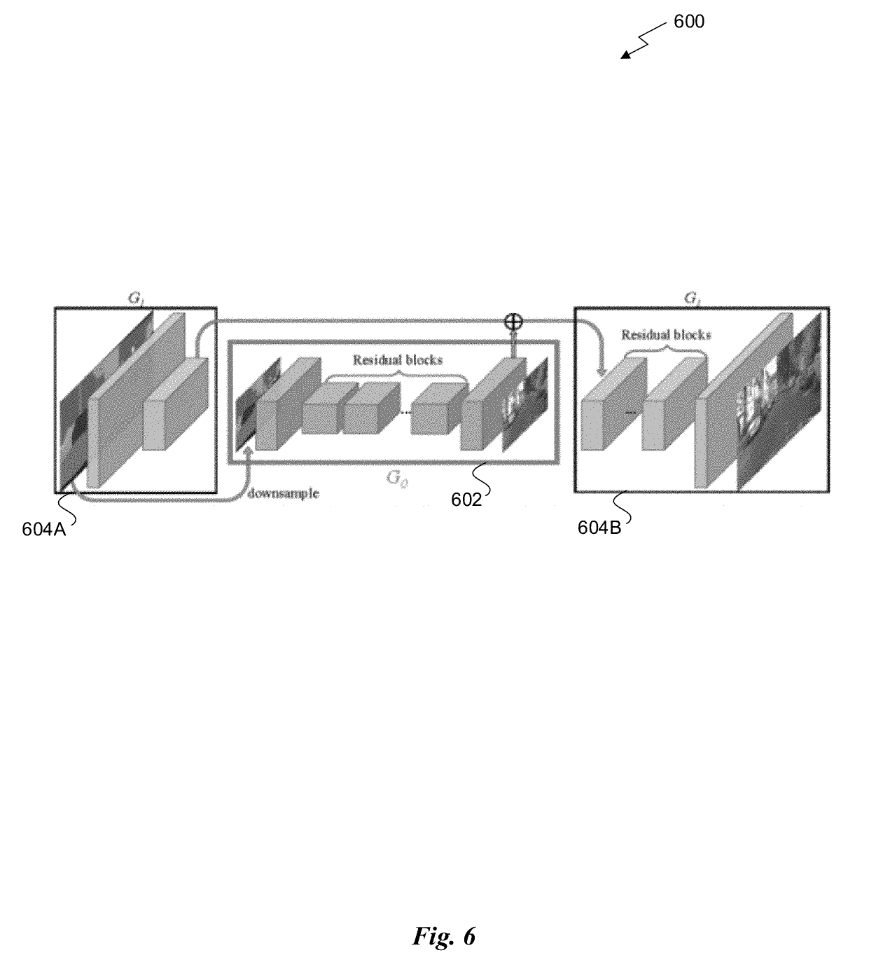

FIG. 6 illustrates an exemplary network architecture of a generator 600, according to one embodiment. In one embodiment, we first train a residual network (G₀) 602 on lower resolution images. Then this network is used to initialize our final network trained on high resolution images (G₁) 604A-B. Specifically, the input to the residual blocks in G₁ 604A-B is the element-wise sum of the feature map from G₁ 604A-B and the last feature map from (G₀) 602.

In one embodiment, the global generator network operates at a resolution of 1024×512, and the local enhancer network outputs an image with a resolution that is four times larger than the output of the previous one (two times larger along each image dimension). In one embodiment, for synthesizing images with an even higher resolution, additional local enhancer networks could be utilized. In one embodiment, the output image resolution of the generator G={G₁; G₀} is 2048×1024 and the output image resolution of G={G₂; G₁; G₀} is 4096×2048.

In one embodiment, the global generator network may be based on a network architecture which utilizes residual blocks. In one embodiment, the architecture consists of three components: a convolutional front-end G₀^{(F)}, a set of residual blocks G₀^{(R)}, and a transposed convolutional back-end G₀^{(B)}. In one embodiment, a semantic label map of resolution 1024×512 is passed through the three components sequentially to output an image of resolution 1024×512.

In one embodiment, the local enhancer network also consists of three components: a convolutional front-end G₁^{(F)}, a set of residual blocks G₁^{(R)}, and a transposed convolutional back-end G₁^{(B)}. In one embodiment, the resolution of the input semantic label map to G₁ is 2048×1024. Different to the global generator network, the input to the residual block G₁^{(R)} is the element-wise sum of two feature maps: the output feature map of G₁^{(F)}, and the last feature map of the back-end of the global generator network G₀^{(B)}. This helps integrating the global information from G₀ to G₁. In one embodiment, when employing a further local enhancer network G₂ for synthesizing images with a higher resolution, the input to the residual block G₂^{(R)} is the element-wise sum of the output feature map of G₂^{(F)} and the last feature map of G₁^{(B)}.

In one embodiment, during training, we first train the global generator and then train the local enhancer in the order of their resolutions. We then jointly finetune all the networks together. We use this generator design to effectively aggregate global and local information for the image synthesis task.

Multi-Scale Discriminators

High-resolution image synthesis poses a challenge to the GAN discriminator design. In one embodiment, for differentiating high-resolution real and synthesized images, the discriminator needs to have a large receptive field. This would require either a deep network or large convolutional kernels. As both choices lead to an increased network capacity, overfitting would become more of a concern. Also, both choices require a larger memory footprint for training, which is already a scarce resource for high resolution image generation.

In one embodiment, to address the issue, we propose using multi-scale discriminators. In one embodiment, we use three discriminators that have an identical network structure (three-layer convolutional network) but operate at different image scales. We will refer to the discriminators as D₁, D₂ and D₃. In one embodiment, we downsample the real and synthesized high-resolution images by a factor of two and four to create an image pyramid of three scales. The discriminators D₁, D₂ and D₃ are then trained to differentiate real and synthesized images at the three different scales, respectively. In one embodiment, although the discriminators have an identical architecture, the one that operates at the coarsest scale has the largest receptive field. It has a more global view of the image and can guide the generator to generate globally consistent images. On the other hand, the discriminator operating at the finest scale is specialized in guiding the generator to generate finer details. This also makes training the coarse to fine generator easier, since extending it to a higher resolution only requires adding an additional discriminator at the finest level, rather than retraining from scratch. With the discriminators, the learning problem in (1) then becomes a multi-task learning problem of:

$${max}_{G} {min}_{{D}_{1} , {D}_{2} , {D}_{3}} {\sum }_{k = 1 , 2 , 3}^{ } {}_{GAN} ( G , {D}_{k} ) \qquad ( 3 )$$

In one embodiment, the design may be extended to multiple discriminators at different image scales for modeling high-res images.

Improved Adversarial Loss

In one embodiment, we improve the GAN loss in (2) for the high-resolution image synthesis task by incorporating a GAN-discriminator feature matching loss. In one embodiment, we use the GAN discriminator as a feature extractor, and learn to match the intermediate feature representations extracted from the real image and the synthesized image. For ease of presentation, we denote the ith-layer feature extractor of discriminator Dₖ as Dₖ⁽ⁱ⁾ (from input to the ith layer of Dₖ). The feature matching loss [symbol] _{F}=(G, Dₖ) is then given by:

$${ℒ}_{F} = {\sum }_{i ∈ \{ 1 . . . T - 1 \}}^{ } {𝔼}_{( s , x )} [ {‖ {D}_{k}^{( i )} ( s , x ) - {D}_{k}^{( i )} ( s , G ( s ) ) ‖}_{1}^{1} ] , \qquad ( 4 )$$

where T is the number of layers in the discriminator. In one embodiment, our GAN discriminator feature matching loss is related to the perceptual loss (or VGG-feature matching loss), which is shown useful for image super-resolution and style transfer.

Combining the GAN loss and GAN discriminator feature matching loss, the learning problem is given by

$${max}_{G} {min}_{{D}_{1} , {D}_{2} , {D}_{3}} {\sum }_{k = 1 , 2 , 3}^{ } {ℒ}_{GAN} ( G , {D}_{k} ) + {λℒ}_{F} ( G , {D}_{k} ) , \qquad ( 5 )$$

where λ is a weighting parameter. In one embodiment, λ>1 may improve performance. In one embodiment, we set it to ten in all of our experiments.

Using the Instance Map

In one embodiment, a semantic label map is an image where the pixel value represents the object class that the pixel belongs to. In one embodiment, this map does not differentiate objects of the same class. On the other hand, an instance-level semantic label map contains a unique object ID for each individual object. Existing image synthesis methods only utilize semantic label maps. In the following, we propose two approaches to utilize instance maps when they are available.

Instance Boundary Map

In one embodiment, we argue that the most important information the instance map provides, which is not available in the semantic label map, is the object boundary. In one embodiment, when a number of same-class objects are next to one another, looking at the semantic label map alone cannot tell them apart. This is especially true for a street scene since many parked cars or walking pedestrians are often next to one another. However, when given the instance map, separating these objects apart becomes an easier task.

Therefore, to extract this information, in one embodiment we first compute the instance boundary map. In one embodiment, a pixel in the instance boundary map is one if its object ID is different from any of its four-neighbors, and 0 otherwise. In one embodiment, the instance boundary map is then concatenated with the input semantic label map (encoded as one-hot vectors) and fed into the generator network. Similarly, the input to the discriminator is the channel-wise concatenation of instance boundary map, semantic label map, and the real/synthesized image.

Instance-Level Discriminator

In one embodiment, with the instance maps, we are able to apply specialized GAN discriminators to individual instances in the image to further improve the image synthesis performance. Specifically, we crop image regions in both real and synthesized images based on the instance maps. The cropped images of the instances are then divided into different groups based on their semantic classes. Class-specific GAN discriminators are then employed to differentiate real and synthesized image regions in the same group. In one embodiment, we apply the class-specific discriminator to car instances, and only if the bounding box of the car instance is larger than 128×128. This technique helps the generator synthesize cars with more semantically uniform appearances.

Using the Instance Feature Map

In one embodiment, image synthesis from semantic label maps is a multimodal mapping problem. An image synthesis algorithm should be able to generate diverse realistic images using the same semantic label map.

In one embodiment, to enable the capability of generating diverse images and allow instance-level control, we propose adding additional feature channels to the input to the generator network. We show that, by manipulating these features, we can have more control on the image synthesis process. We note that since the features are continuous quantities, they are capable of generating infinitely many images.

In one embodiment, to generate the needed features, we train an encoder network to embed the input images. We use an encoder architecture that is similar to our generator. To ensure the features are uniform within each instance, we add an instance-wise average pooling layer to the output of the encoder to compute the average feature for the instance. The average feature is then broadcasted to all the pixel locations of the instance.

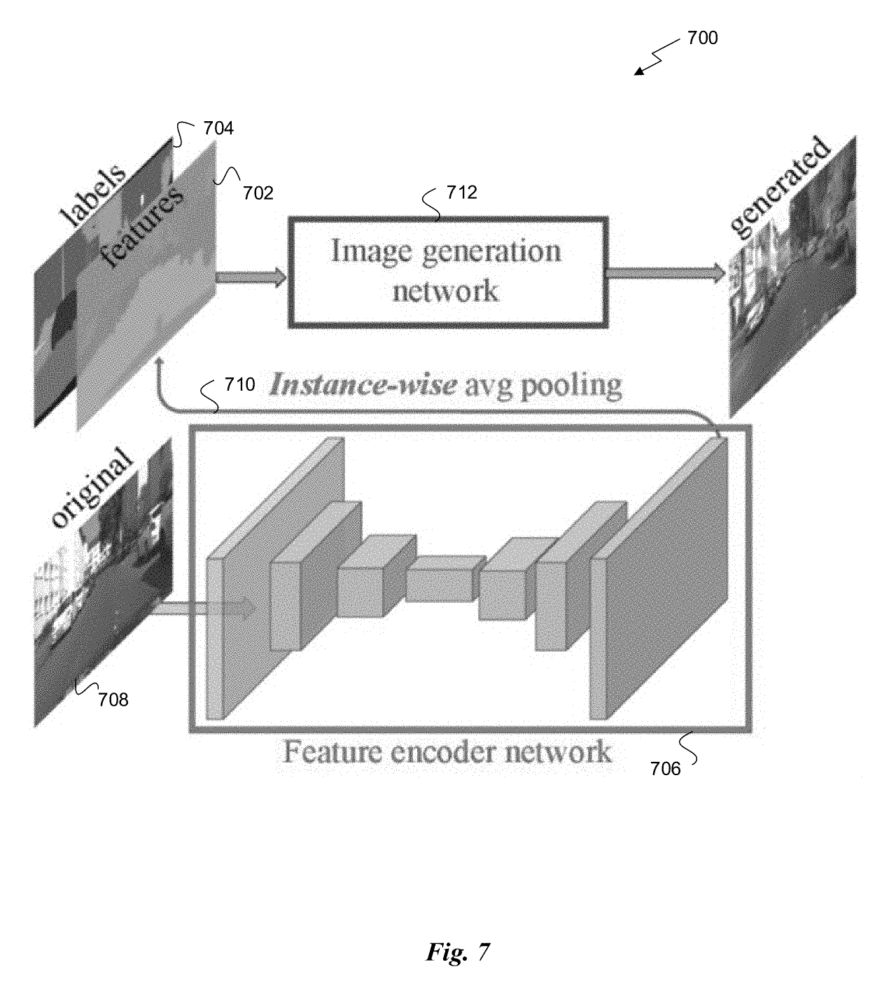

FIG. 7 illustrates an exemplary trained encoder architecture 700, according to one exemplary embodiment. In one embodiment, using instance-wise feature maps 702 in addition to label maps 704 for generating images, we first run an encoder network 706 on the original image 708, and then perform an instance-wise average pooling 710 so that each instance shares the same features. This feature map is then concatenated with the label map and fed into the image generation network 712. In one embodiment, the image generation network 712 and the encoder network 706 are trained end-to-end together to output the final image.

In one embodiment, the encoder is trained with the generators and discriminators end-to-end for solving (5). In one embodiment, after the encoder is trained, we run it on all instances in the training images and record the obtained features. In one embodiment, we then perform a K-means clustering on these features for each semantic label type. Each cluster thus encodes the features for a specific style, In one embodiment tar or cobblestone for a road. In one embodiment, at inference time, we randomly pick one of the cluster centers and use it as the encoded features. These features are concatenated with the label map and used as the input to our generator.

Interactive Object Editing

In one embodiment, given our feature-assisted network, we are also able to perform interactive instance editing on the resulting images. In one embodiment, we can change the colors of individual cars, or the styles of the road. We can also change the labels in the image to generate different results, such as replacing trees with buildings. This enables very user-friendly manipulating of the images. In addition, we also implement our instance-editing feature on a Face dataset where labels for different facial parts are available. This makes it easy to manipulate face images (e.g., by changing the face color to mimic different make-up effects, or adding beards to a face, etc.).

Discussion

In one embodiment, conditional GANs may synthesize high-resolution photorealistic imagery without any hand-crafted losses or pre-trained networks. In one embodiment, incorporating a perceptual loss can slightly improve the results with extra computational cost. Our method will allow many applications, especially useful for the domains where high-resolution results are in demand but pretrained networks are not available (e.g. medical imaging, biology, etc.). Moreover, an image-to-image synthesis pipeline can be extended to produce diverse outputs and enable interactive image manipulation given the appropriate training input-output pairs (e.g. instance maps in our case).

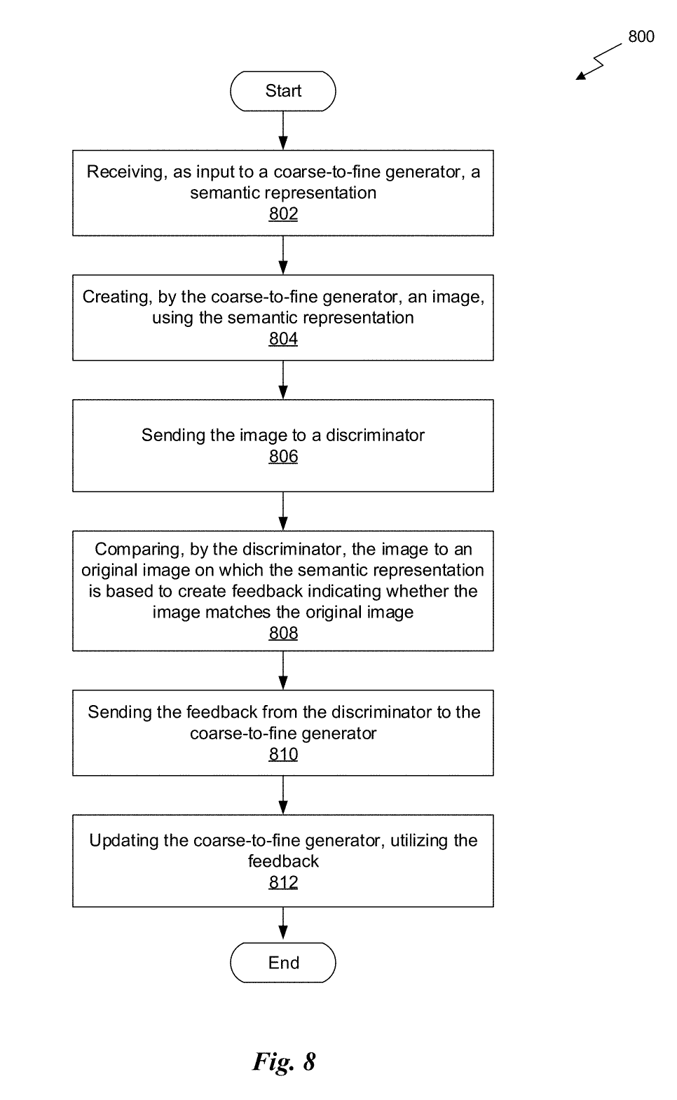

FIG. 8 illustrates a flowchart of a method 800 for training a coarse-to-fine generator, in accordance with an embodiment. Although method 800 is described in the context of a processing unit, the method 800 may also be performed by a program, custom circuitry, or by a combination of custom circuitry and a program. In one embodiment, the method 800 may be executed by a GPU (graphics processing unit), CPU (central processing unit), or any processor capable of performing parallel path space filtering by hashing. Furthermore, persons of ordinary skill in the art will understand that any system that performs method 800 is within the scope and spirit of embodiments of the present invention.

As shown in operation 802, a semantic representation is received as input to a coarse-to-fine generator. Additionally, as shown in operation 804, the coarse-to-fine generator creates an image, using the semantic representation. Further, as shown in operation 806, the image is sent to a discriminator.

Further still, as shown in operation 808, the discriminator compares the image to an original image on which the semantic representation is based to create feedback indicating whether the image matches the original image. In one embodiment, the discriminator may include a plurality of multi-scale discriminators that each include a neural network separate from the other multi-scale discriminators.

In one embodiment, the image may be downsampled multiple times to create a plurality of downsampled images, and each of the plurality of multi-scale discriminators may operate at an image scale different from the other multi-scale discriminators, and may analyze one of the plurality of downsampled images. In one embodiment, the discriminator may extract a first set of intermediate feature representations from the image, and may also extract a second set of intermediate feature representations from the original image on which the semantic representation is based.

In one embodiment, the discriminator may compare the first set of intermediate feature representations to the second set of intermediate feature representations to create feedback, where the feedback includes an indication as to whether the intermediate feature representations match.

Also, as shown in operation 810, the discriminator sends the feedback to the coarse-to-fine generator. In addition, as shown in operation 812, the coarse-to-fine generator is updated, utilizing the feedback. In one embodiment, updating the coarse-to-fine generator may include changing one or more decisions made by the coarse-to-fine generator during image creation, based on the feedback.

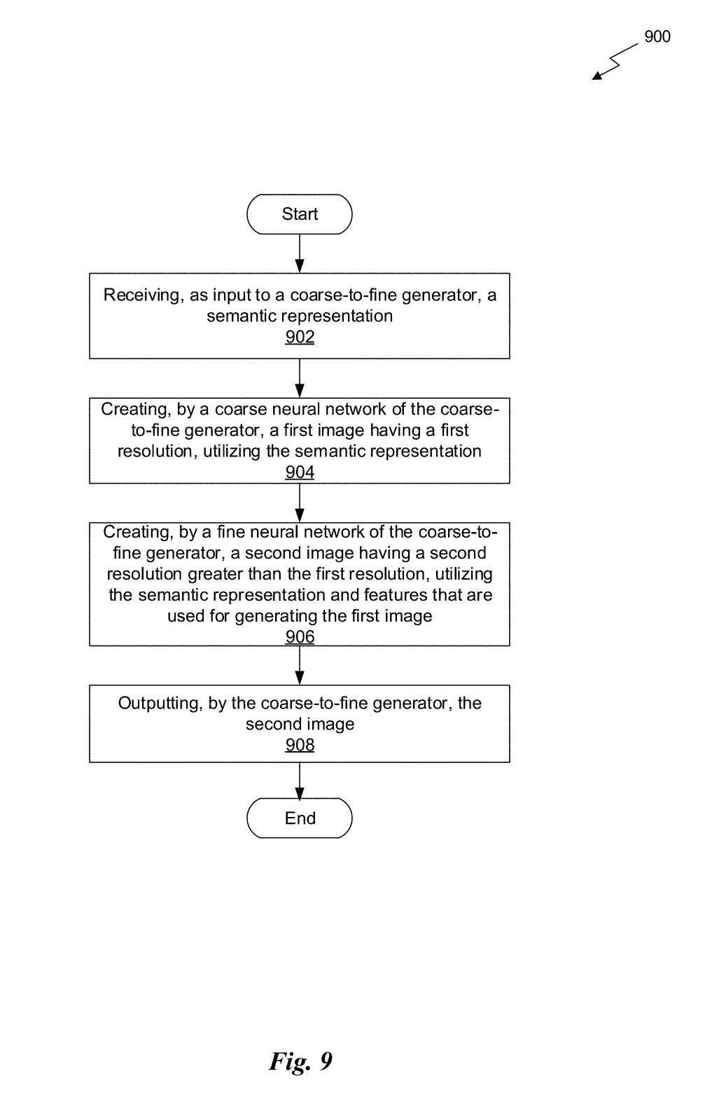

FIG. 9 illustrates a flowchart of a method 900 for implementing a trained coarse-to-fine generator, in accordance with an embodiment. Although method 900 is described in the context of a processing unit, the method 900 may also be performed by a program, custom circuitry, or by a combination of custom circuitry and a program. In one embodiment, the method 900 may be executed by a GPU (graphics processing unit), CPU (central processing unit), or any processor capable of performing parallel path space filtering by hashing. Furthermore, persons of ordinary skill in the art will understand that any system that performs method 900 is within the scope and spirit of embodiments of the present invention.

As shown in operation 902, a semantic representation is received as input to a coarse-to-fine generator. Additionally, as shown in operation 904, a coarse neural network of the coarse-to-fine generator creates a first image having a first resolution, utilizing the semantic representation.

Further, as shown in operation 906, a fine neural network of the coarse-to-fine generator creates a second image having a second resolution greater than the first resolution, utilizing the semantic representation and features that are used for generating the first image. In one embodiment, the features that are used for generating the first image may include one or more intermediate feature layers of the coarse network. Further still, as shown in operation 908, the coarse-to-fine generator outputs the second image.

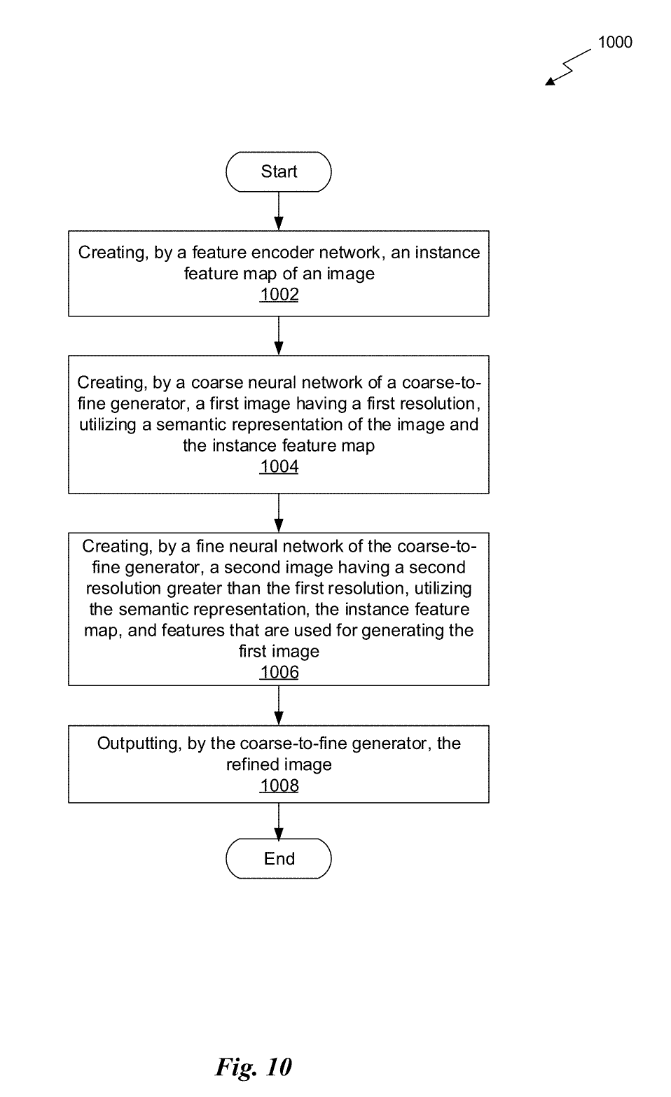

FIG. 10 illustrates a flowchart of a method 1000 for refining output utilizing an instance feature map, in accordance with an embodiment. Although method 1000 is described in the context of a processing unit, the method 1000 may also be performed by a program, custom circuitry, or by a combination of custom circuitry and a program. In one embodiment, the method 1000 may be executed by a GPU (graphics processing unit), CPU (central processing unit), or any processor capable of performing parallel path space filtering by hashing. Furthermore, persons of ordinary skill in the art will understand that any system that performs method 1000 is within the scope and spirit of embodiments of the present invention.

As shown in operation 1002, a feature encoder network creates an instance feature map of an image. In one embodiment, the feature encoder network may use instance-wise average pooling to ensure that features are uniform within the instance feature map. Additionally, as shown in operation 1004, a coarse neural network of a coarse-to-fine generator creates a first image having a first resolution, utilizing the semantic representation of the image and the instance feature map.

Further, as shown in operation 1006, a fine neural network of the coarse-to-fine generator creates a second image having a second resolution greater than the first resolution, utilizing the semantic representation, the instance feature map, and features that are used for generating the first image. Further still, as shown in operation 1008, the coarse-to-fine generator outputs the second image. In this way, the instance feature map may allow instance-level manipulation of the output image (e.g., by changing a style of an object such as a car or the texture of an object such as a road), in addition to refining the output.

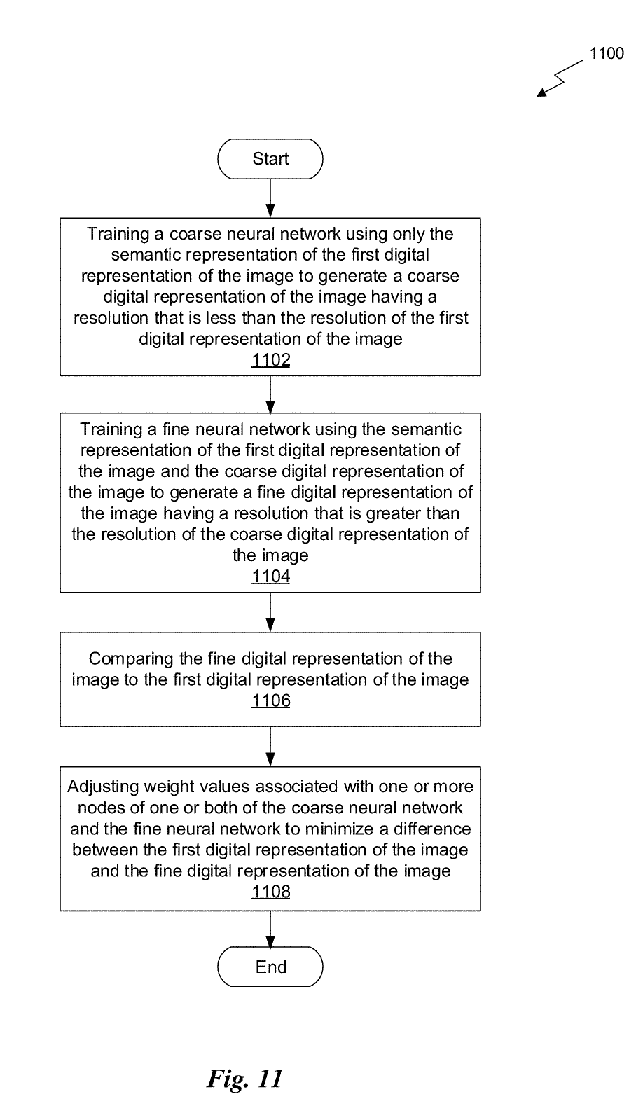

FIG. 11 illustrates a flowchart of a method 1100 for training a machine learning model based, at least in part, on a semantic representation of a first digital representation of an image, in accordance with an embodiment. Although method 1100 is described in the context of a processing unit, the method 1100 may also be performed by a program, custom circuitry, or by a combination of custom circuitry and a program. In one embodiment, the method 1100 may be executed by a GPU (graphics processing unit), CPU (central processing unit), or any processor capable of performing parallel path space filtering by hashing. Furthermore, persons of ordinary skill in the art will understand that any system that performs method 1100 is within the scope and spirit of embodiments of the present invention.

As shown in operation 1102, a coarse neural network is trained using only the semantic representation of the first digital representation of the image to generate a coarse digital representation of the image having a resolution that is less than the resolution of the first digital representation of the image. In one embodiment, the semantic representation of the first digital representation of the image includes a semantic label map of the first digital representation of the image. In one embodiment, the semantic representation of the first digital representation of the image includes an edge map of the first digital representation of the image. In one embodiment, the semantic representation of the first digital representation of the image includes a relationship map of the first digital representation of the image.

Additionally, as shown in operation 1104, a fine neural network is trained using the semantic representation of the first digital representation of the image and the coarse digital representation of the image to generate a fine digital representation of the image having a resolution that is greater than the resolution of the coarse digital representation of the image.

Further, as shown in operation 1106, the fine digital representation of the image is compared to the first digital representation of the image. Further still, as shown in operation 1108, weight values associated with one or more nodes of one or both of the coarse neural network and the fine neural network are adjusted to minimize a difference between the first digital representation of the image and the fine digital representation of the image.

Further still, in one embodiment, a downsampled fine digital representation of the image may be generated utilizing the fine digital representation of the image, where the downsampled fine digital representation of the image has a resolution that is less than the resolution of the fine digital representation of the image. In one embodiment, a downsampled first digital representation of the image having a resolution that is less than the resolution of the first digital representation of an image may be generated utilizing the first digital representation of the image.

Also, in one embodiment, the downsampled fine digital representation of the image may be compared to the downsampled first digital representation of the image, and weight values associated with one or more nodes of one or both of the coarse neural network and the fine neural network may be adjusted to minimize a difference between the downsampled fine digital representation of the image and the downsampled first digital representation of the image.

In addition, in one embodiment, a set of intermediate feature representations of the fine digital representation of the image may be extracted utilizing the fine digital representation of the image. In one embodiment, a set of intermediate feature representations of the first digital representation of the image may be extracted utilizing the first digital representation of the image. In one embodiment, the set of intermediate feature representations of the fine digital representation of the image may be compared to the set of intermediate feature representations of the first digital representation of the image, and weight values associated with one or more nodes of one or both of the coarse neural network and the fine neural network may be adjusted to minimize a difference between the set of intermediate feature representations of the fine digital representation of the image and the set of intermediate feature representations of the first digital representation of the image.

Furthermore, in one embodiment, the machine learning model may also be trained based, at least in part, on an instance feature map of the first digital representation of the image. In one embodiment, the instance feature map of the first digital representation of the image may be added to the semantic representation of the first digital representation of the image as input to the machine learning model.

In one embodiment, a plurality of downsampled fine digital representations of the image having resolutions less than the resolution of the fine digital representation of the image may be generated utilizing the fine digital representation of the image. In one embodiment, a plurality of downsampled first digital representations of the image having resolutions less than the resolution of the first digital representation of an image may also be generated utilizing the first digital representation of the image. In one embodiment, the fine digital representation of the image and the downsampled fine digital representations of the image may be compared to the the first digital representation of the image and the downsampled first digital representations of the image by a plurality of neural networks, where each of the plurality of neural networks operates at a resolution different from the other neural networks. In one embodiment, weight values associated with one or more nodes of one or both of the coarse neural network and the fine neural network may be adjusted to minimize a difference between the fine digital representation of the image and the downsampled fine digital representations of the image, and the first digital representation of the image and the downsampled first digital representations of the image.

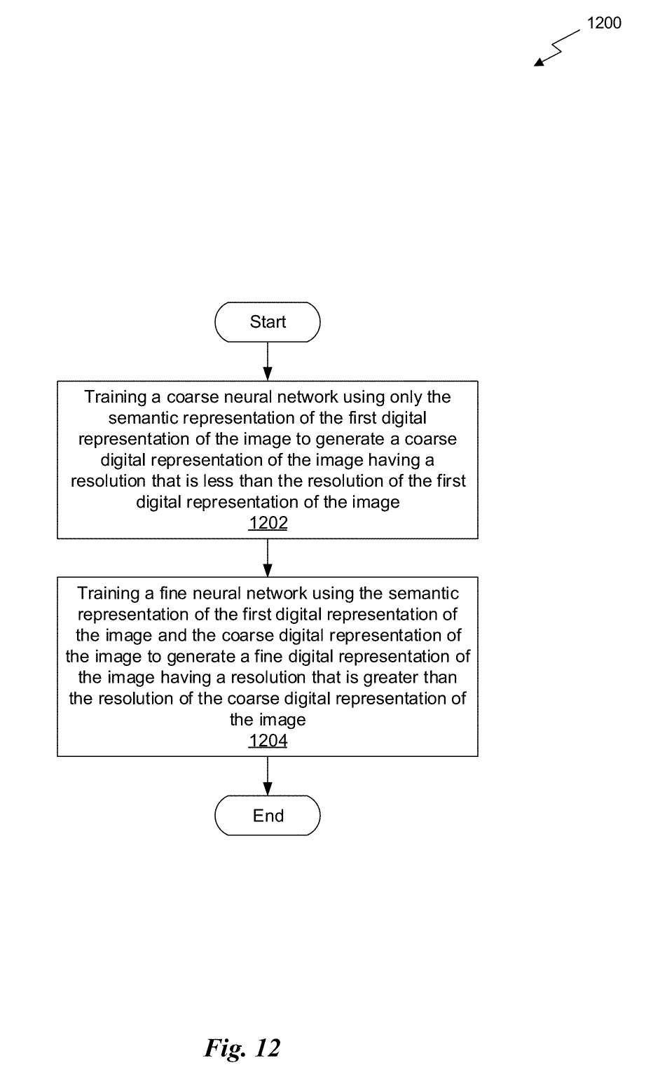

FIG. 12 illustrates a flowchart of a method 1200 for training a machine learning model based, at least in part, on a semantic representation of a first digital representation of an image, in accordance with an embodiment. Although method 1200 is described in the context of a processing unit, the method 1200 may also be performed by a program, custom circuitry, or by a combination of custom circuitry and a program. In one embodiment, the method 1200 may be executed by a GPU (graphics processing unit), CPU (central processing unit), or any processor capable of performing parallel path space filtering by hashing. Furthermore, persons of ordinary skill in the art will understand that any system that performs method 1200 is within the scope and spirit of embodiments of the present invention.

As shown in operation 1202, a coarse neural network is trained using only the semantic representation of the first digital representation of the image to generate a coarse digital representation of the image having a resolution that is less than the resolution of the first digital representation of the image. In one embodiment, the semantic representation of the first digital representation of the image includes a semantic label map of the first digital representation of the image. In one embodiment, the semantic representation of the first digital representation of the image includes an edge map of the first digital representation of the image. In one embodiment, the semantic representation of the first digital representation of the image includes a relationship map of the first digital representation of the image.

Additionally, as shown in operation 1204, a fine neural network is trained using the semantic representation of the first digital representation of the image and the coarse digital representation of the image to generate a fine digital representation of the image having a resolution that is greater than the resolution of the coarse digital representation of the image.

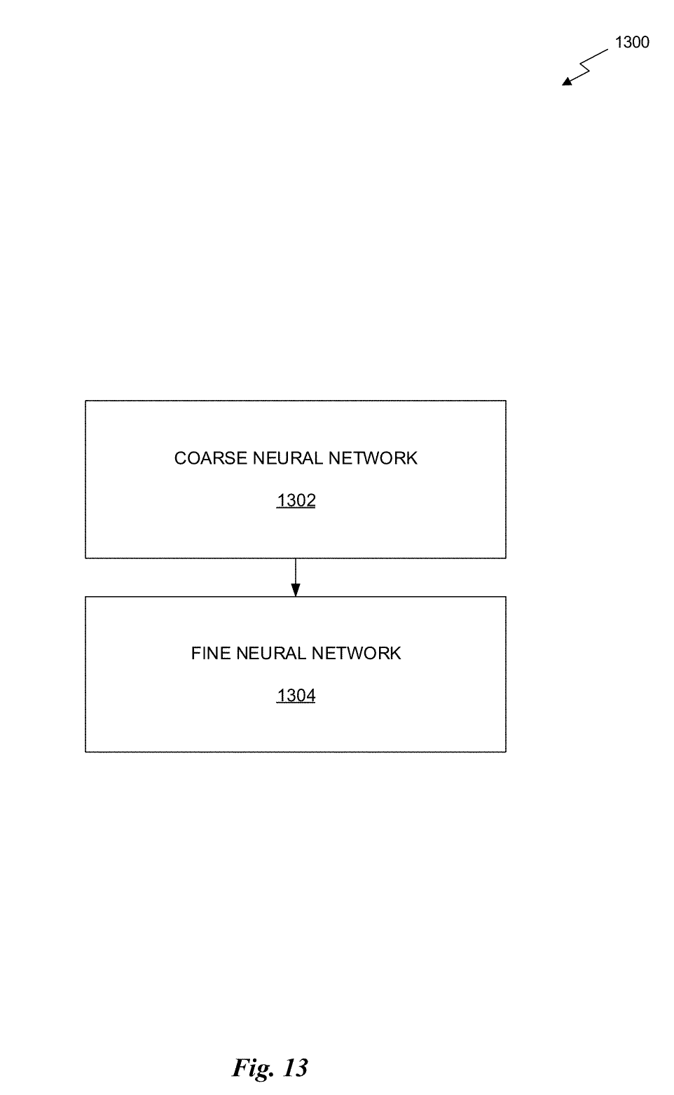

FIG. 13 illustrates an exemplary machine learning model 1300, in accordance with an embodiment. As shown, exemplary machine learning model 1300 includes a coarse neural network 1302 and a fine neural network 1304. In one embodiment, the coarse neural network 1302 may generate, using only a semantic representation of a first digital representation of an image, a coarse digital representation of the image having a resolution that is less than the resolution of the first digital representation of the image.

Additionally, in one embodiment, the fine neural network 1304 may generate, using the semantic representation of the first digital representation of the image and the coarse digital representation of the image, a fine digital representation of the image having a resolution that is greater than the resolution of the coarse digital representation of the image.

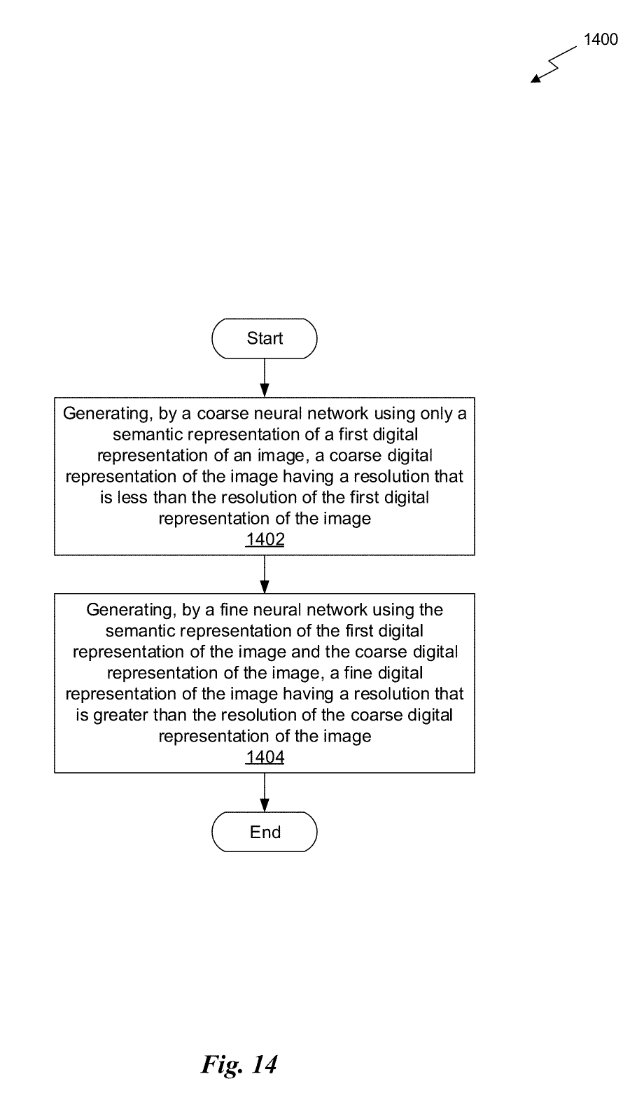

FIG. 14 illustrates a flowchart of a method 1400 for using a trained generator architecture, in accordance with an embodiment. Although method 1400 is described in the context of a processing unit, the method 1400 may also be performed by a program, custom circuitry, or by a combination of custom circuitry and a program. In one embodiment, the method 1400 may be executed by a GPU (graphics processing unit), CPU (central processing unit), or any processor capable of performing parallel path space filtering by hashing. Furthermore, persons of ordinary skill in the art will understand that any system that performs method 1400 is within the scope and spirit of embodiments of the present invention.

As shown in operation 1402, a coarse neural network generates a coarse digital representation of the image having a resolution that is less than the resolution of the first digital representation of the image, using only a semantic representation of a first digital representation of an image. Additionally, as shown in operation 1404, a fine neural network generates a fine digital representation of the image having a resolution that is greater than the resolution of the coarse digital representation of the image, using the semantic representation of the first digital representation of the image and the coarse digital representation of the image.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method comprising:
training a machine learning model based, at least in part, on a semantic representation of a first digital representation of an image, wherein training the machine learning model includes:
training a coarse neural network using only the semantic representation of the first digital representation of the image to generate a coarse digital representation of the image having a resolution that is less than the resolution of the first digital representation of the image;
training a fine neural network using the semantic representation of the first digital representation of the image and the coarse digital representation of the image to generate a fine digital representation of the image having a resolution that is greater than the resolution of the coarse digital representation of the image;
comparing the fine digital representation of the image to the first digital representation of the image; and
adjusting weight values associated with one or more nodes of one or both of the coarse neural network and the fine neural network to minimize a difference between the first digital representation of the image and the fine digital representation of the image.

2. The method of claim 1, wherein the semantic representation of the first digital representation of the image includes a semantic label map of the first digital representation of the image.

3. The method of claim 1, wherein the semantic representation of the first digital representation of the image includes an edge map of the first digital representation of the image.

4. The method of claim 1, wherein the semantic representation of the first digital representation of the image includes a relationship map of the first digital representation of the image.

5. The method of claim 1, further comprising generating, utilizing the fine digital representation of the image, a downsampled fine digital representation of the image having a resolution that is less than the resolution of the fine digital representation of the image.

6. The method of claim 5, further comprising generating, utilizing the first digital representation of the image, a downsampled first digital representation of the image having a resolution that is less than the resolution of the first digital representation of an image.

7. The method of claim 6, further comprising comparing the downsampled fine digital representation of the image to the downsampled first digital representation of the image.

8. The method of claim 7, further comprising adjusting weight values associated with one or more nodes of one or both of the coarse neural network and the fine neural network to minimize a difference between the downsampled fine digital representation of the image and the downsampled first digital representation of the image.

9. The method of claim 1, further comprising:
generating, utilizing the fine digital representation of the image, a plurality of downsampled fine digital representations of the image having resolutions less than the resolution of the fine digital representation of the image;
generating, utilizing the first digital representation of the image, a plurality of downsampled first digital representations of the image having resolutions less than the resolution of the first digital representation of an image;
comparing, by a plurality of neural networks, the fine digital representation of the image and the downsampled fine digital representations of the image to the first digital representation of the image and the downsampled first digital representations of the image, where each of the plurality of neural networks operates at a resolution different from the other neural networks; and
adjusting weight values associated with one or more nodes of one or both of the coarse neural network and the fine neural network to minimize a difference between the fine digital representation of the image and the downsampled fine digital representations of the image, and the first digital representation of the image and the downsampled first digital representations of the image.

10. The method of claim 1, further comprising extracting, utilizing the fine digital representation of the image, a set of intermediate feature representations of the fine digital representation of the image.

11. The method of claim 10, further comprising extracting, utilizing the first digital representation of the image, a set of intermediate feature representations of the first digital representation of the image.

12. The method of claim 11, further comprising comparing the set of intermediate feature representations of the fine digital representation of the image to the set of intermediate feature representations of the first digital representation of the image.

13. The method of claim 12, further comprising adjusting weight values associated with one or more nodes of one or both of the coarse neural network and the fine neural network to minimize a difference between the set of intermediate feature representations of the fine digital representation of the image and the set of intermediate feature representations of the first digital representation of the image.

14. The method of claim 1, wherein the machine learning model is also trained based, at least in part, on an instance feature map of the first digital representation of the image.

15. The method of claim 14, wherein the instance feature map of the first digital representation of the image is added to the semantic representation of the first digital representation of the image as input to the machine learning model.

16. A method comprising:
training a machine learning model based, at least in part, on a semantic representation of a first digital representation of an image, wherein training the machine learning model includes:
training a coarse neural network using only the semantic representation of the first digital representation of the image to generate a coarse digital representation of the image having a resolution that is less than the resolution of the first digital representation of the image; and
training a fine neural network using the semantic representation of the first digital representation of the image and the coarse digital representation of the image to generate a fine digital representation of the image having a resolution that is greater than the resolution of the coarse digital representation of the image.

17. A machine learning model that includes:
a coarse neural network that generates, using only a semantic representation of a first digital representation of an image, a coarse digital representation of the image having a resolution that is less than the resolution of the first digital representation of the image; and
a fine neural network that generates, using the semantic representation of the first digital representation of the image and the coarse digital representation of the image, a fine digital representation of the image having a resolution that is greater than the resolution of the coarse digital representation of the image.

18. The machine learning model of claim 17, wherein the semantic representation of the first digital representation of the image includes a semantic label map of the first digital representation of the image.

19. The machine learning model of claim 17, wherein the semantic representation of the first digital representation of the image includes an edge map of the first digital representation of the image.

20. The machine learning model of claim 17, wherein the semantic representation of the first digital representation of the image includes a relationship map of the first digital representation of the image.

21. The machine learning model of claim 17, wherein the machine learning model also generates the fine digital representation of an image based, at least in part, on an instance feature map of the first digital representation of the image.

22. The machine learning model of claim 21, wherein the instance feature map of the first digital representation of the image is added to the semantic representation of the first digital representation of the image as input to the machine learning model.

23. A method comprising:
generating, by a coarse neural network using only a semantic representation of a first digital representation of an image, a coarse digital representation of the image having a resolution that is less than the resolution of the first digital representation of the image; and
generating, by a fine neural network using the semantic representation of the first digital representation of the image and the coarse digital representation of the image, a fine digital representation of the image having a resolution that is greater than the resolution of the coarse digital representation of the image.
